(19) United States
(12) Patent Application Publication
(10) Pub. No.: US 2026/0275039 A1
(43) Pub. Date: Sep. 17, 2026

(54) CURABLE RESIN COMPOSITION AND CURED PRODUCT THEREOF

(71) Applicant: NIPPON KAYAKU KABUSHIKI KAISHA, Tokyo (JP)

(72) Inventors: Takayuki TOHJIMA, Tokyo (JP); Masanori HASHIMOTO, Tokyo (JP); Masataka NAKANISHI, Tokyo (JP)

(73) Assignee: NIPPON KAYAKU KABUSHIKI KAISHA, Tokyo (JP)

(21) Appl. No.: 19/167,453

(22) PCT Filed: Mar. 18, 2024
(86) PCT No.: PCT/JP2024/010517

§ 371 Date: Sep. 22, 2025

(30) Foreign Application Priority Data
Mar. 23, 2023 (JP) 2023-046175

(51) Int. Cl. C08G 73/12; C08F 8/32; C08F 222/40

(52) U.S. Cl. CPC C08G 73/12; C08F 8/32; C08F 222/40

(57) ABSTRACT

The present invention provides a curable resin composition having an excellent low dielectric loss tangent, and a cured product thereof. Provided is a curable resin composition containing a compound represented by formula (1) and a maleimide compound having a maleimide equivalent weight of from 450 g/eq to 2000 g/eq. In formula (1), the multiple R each independently represent a hydrogen atom, a C1 to 10 hydrocarbon group, or a C1 to 10 halogenated alkyl group. p represents an integer of 0 to 4, r represents an integer of 0 to 4, and q represents an integer of 0 to 3. n is the average number of repetitions and is 1≤n≤20.

### TECHNICAL FIELD

The present invention relates to a curable resin composition and a cured product thereof, which are suitably used in electrical and electronic components such as semiconductor encapsulants, printed wiring boards, and build-up laminates, lightweight, high-strength materials such as carbon fiber reinforced plastics and glass fiber reinforced plastics, and 3D printing applications.

### BACKGROUND ART

In recent years, the laminates on which electric and electronic components are mounted have come to be used in a wider range of fields, and the required characteristics have become more extensive and sophisticated. Conventional semiconductor chips were mainly mounted on metal lead frames, but semiconductor chips with high processing power, such as central processing units (hereinafter referred to as CPUs), are increasingly being mounted on laminates made of polymer materials.

The fifth generation communication system “5G”, whose development is currently accelerating, is expected to further increase capacity and speed of communication. In 5G, the frequency used will become higher, but in order to realize high-speed communication using high frequencies, it is important to reduce transmission loss, and further reduction in dielectric tangent of the board material will be required. The transmission loss occurring on the printed circuit board is due to conductor loss and dielectric loss. As described in Non-Patent Document 1, the dielectric loss αD is proportional to the square root of the relative dielectric constant εᵣ of the dielectric and the dielectric tangent tan δ, so it can be said that improving the dielectric tangent tan δ, which has a higher contribution than the relative dielectric constant er, is effective in reducing transmission loss. Thermoplastic materials such as PTFE (polytetrafluoroethylene) and LCP (liquid crystal polymer) are examples of materials with low dielectric tangent, but they are poor in moldability compared to thermosetting resins. In light of this, the development of thermosetting resins that exhibit low dielectric tangent is desired.

In light of this background, thermosetting resins exhibiting low dielectric tangents have been studied. For example, Patent Document 1 proposes a thermosetting resin composition containing an imide compound having a maleimide group and a phenol aralkyl resin having an aliphatic unsaturated bond. However, on the other hand, since phenolic hydroxy groups that do not participate in the reaction remain during the curing reaction, the electrical properties are not sufficient. Patent Document 2 also discloses an allyl ether-modified biphenyl aralkyl novolac resin to which an allyl group is added together with a phenolic hydroxy group. However, the allyl ether-modified biphenyl aralkyl novolac resin undergoes Claisen rearrangement at 190° C., and at 200° C., which is the molding temperature of a general substrate, phenolic hydroxy groups that do not contribute to the curing reaction are generated, so the electrical properties are not satisfactory.

### CITATION LIST

### Non Patent Literature

Non Patent Literature 1: “Consideration of signal loss factor in the high-speed Signal transmission on a printed Circuit board”, 29th Spring Conference of the Japan Institute of Electronics Packaging, Session ID: 16P1-17, 2015

### Patent Literature

Patent Literature 1: Japanese Patent Publication No. H04-359911
Patent Literature 2: International Publication No. 2016/002704

### SUMMARY OF INVENTION

### Technical Problem

Furthermore, in recent years, there has been a demand for low dielectric tangents that are excellent not only at the initial value but also over a long period of time. Specifically, there has been a demand for low dielectric tangents that are excellent even after exposure to high temperatures and after water absorption tests.

The present invention has been made in view of the above circumstances, and an object of the present invention is to provide a curable resin composition having an excellent low dielectric tangent, and a cured product thereof.

### Solution to Problem

That is, the present invention relates to the following [1] to [5]. In this application, “(Numerical value 1) to (Numerical value 2)” indicates that the upper and lower limits are included.
[1] A curable resin composition comprising a compound represented by the following formula (1) and a maleimide compound having a maleimide equivalent of 450 g/eq. or more and 2000 g/eq. or less.

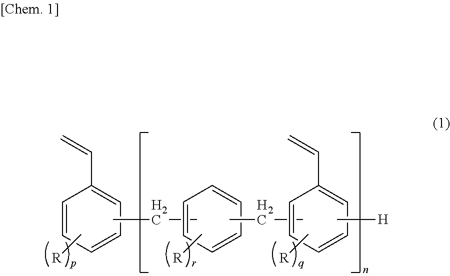

In formula (1), each of the multiple R independently represents a hydrogen atom, a hydrocarbon group having 1 to 10 carbon atoms, or a halogenated alkyl group having 1 to 10 carbon atoms. p represents an integer of 0 to 4, r represents an integer of 0 to 4, and q represents an integer of 0 to 3. n represents the average number of repetitions, and is 1≤n≤20.
[2] The curable resin composition according to the above item [1], wherein the maleimide compound is a maleimide compound having a polystyrene structure in the molecule.
[3] The curable resin composition according to the above item [1] or [2], further comprising a polymerization initiator.
[4] The curable resin composition according to any one of the above items [1] to [3], further comprising at least one selected from the group consisting of a maleimide compound other than the maleimide compound, a polyphenylene ether compound, a compound having an ethylenically unsaturated bond, a cyanate ester resin, polybutadiene and modified products thereof, polystyrene and modified products thereof, and polyethylene and modified products thereof.
[5] A cured product obtained by curing the curable resin composition according to any one of the above items [1] to [4].

### Advantageous Effects of Invention

According to the present invention, it is possible to provide a curable resin composition having an excellent low dielectric tangent, and a cured product thereof.

### BRIEF DESCRIPTION OF DRAWINGS

FIG. 1 shows a GPC chart of Synthesis Example 1.

FIG. 2 shows a GPC chart of Synthesis Example 2.

FIG. 3 shows a ¹H-NMR chart of Synthesis Example 2.

### DESCRIPTION OF EMBODIMENTS

The curable resin composition of the present embodiment contains a compound represented by the following formula (1) and a maleimide compound having a maleimide equivalent of 450 g/eq. or more and 2000 g/eq. or less.

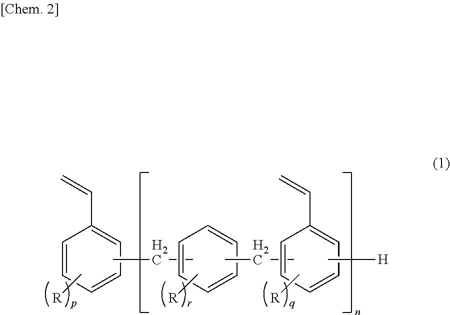

In formula (1), each of the multiple R independently represents a hydrogen atom, a hydrocarbon group having 1 to 10 carbon atoms, or a halogenated alkyl group having 1 to 10 carbon atoms, preferably a hydrogen atom or a hydrocarbon group having 1 to 10 carbon atoms, and more preferably a hydrogen atom or a hydrocarbon group having 1 to 3 carbon atoms. Hydrocarbons having 10 or less carbon atoms are less likely to undergo molecular vibration when exposed to high frequency waves, and therefore have particularly excellent electrical properties.

In formula (1), p is an integer of 0 to 4, preferably an integer of 0 to 2. r is an integer of 0 to 4, preferably an integer of 0 to 2. q is an integer of 0 to 3, preferably an integer of 0 to 2. n is the average number of repetitions, and is preferably 1≤n≤20, more preferably 1.1≤n≤20, particularly preferably 1.1≤n≤10, and most preferably 1.1≤n≤5. The value of n can be calculated from the value of the number average molecular weight (Mn) obtained by measuring the compound represented by formula (1) by gel permeation chromatography (GPC), etc. The number average molecular weight is preferably 200 or more and less than 5000, more preferably 300 or more and less than 3000, and particularly preferably 400 or more and less than 2000. If the weight average molecular weight is less than 5000, purification by washing with water becomes easy, and if it is 200 or more, the target compound does not volatilize in the solvent distillation step.

The compound represented by the formula (1) is derived from a compound represented by the following formula (2).

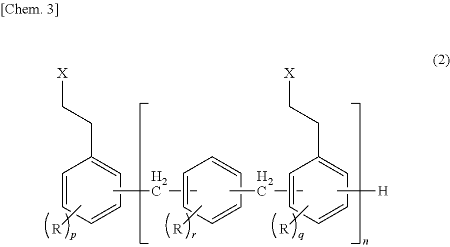

In formula (2), R is the same as in formula (1). The values and preferred ranges of p, r, q, and n are the same as in formula (1). X represents a halogen atom, and from the viewpoints of reactivity and stability of the raw materials, a bromine atom or a chlorine atom is preferable, and a bromine atom is particularly preferable.

The compound represented by the formula (1) can be obtained, for example, by a method of subjecting the compound represented by the formula (2) to a dehydrohalogenation reaction in a solvent in the presence of a basic catalyst. Examples of the solvent to be used include, but are not limited to, water-insoluble solvents such as aromatic solvents such as toluene and xylene, aliphatic solvents such as cyclohexane and n-hexane, ethers such as diethyl ether and diisopropyl ether, ester solvents such as ethyl acetate and butyl acetate, and ketone solvents such as methyl isobutyl ketone and cyclopentanone. Two or more of these may be used in combination. In addition to the water-insoluble solvent, an aprotic polar solvent may also be used in combination. Examples include dimethyl sulfone, dimethyl sulfoxide, dimethylformamide, dimethylacetamide, 1,3-dimethyl-2-imidazolidinone, and N-methylpyrrolidone, and two or more of these may be used in combination. When an aprotic polar solvent is used, it is preferable to use one having a boiling point higher than that of the water-insoluble solvent to be used in combination. The catalyst is not particularly limited, and examples thereof include basic catalysts such as sodium hydroxide, potassium hydroxide, and potassium carbonate. Since it is difficult to completely proceed with the dehydrohalogenation reaction, the aprotic polar solvent may be used in large excess relative to the substrate, and the dehydrohalogenation reaction may be repeated two or more times. For example, the dehydrohalogenation reaction of the compound represented by the formula (2) may be carried out in an organic solvent in the presence of a base catalyst, and the resulting solution may be washed with water and then returned to the reaction vessel, and the base catalyst may be added to carry out the reaction again. This can increase the progress of the dehydrohalogenation reaction. That is, it is possible to reduce the amount of residual halogen contained in the target compound. The amount of residual halogen is preferably 1 to 10,000 ppm in the target product, more preferably 1 to 1,000 ppm, and even more preferably 1 to 750 ppm. If the amount of residual halogen contained in the compound represented by the formula (1) is large, molecular vibration occurs when exposed to high frequency, which has a negative effect on electrical properties, particularly dielectric loss tangent. Furthermore, if the amount of residual halogen is large, the risk of problems such as metal corrosion and ion migration increases in environmental tests such as HAST (High Accelerated Stress Test), so the above-mentioned halogen content is preferable.

The method for producing the compound represented by the formula (2) is not particularly limited, and for example, a compound having a (2-bromoethyl)benzene structure may be reacted with a bishalogenated methylaryl compound (or a bishydroxymethylaryl compound, etc.) in the presence of an acid catalyst such as hydrochloric acid, sulfonic acid, or activated clay, or a compound having a (2-bromoethyl)benzene structure may be reacted with a bishydroxymethylaryl compound in the presence of an acid catalyst such as hydrochloric acid, sulfonic acid, or activated clay. When sulfonic acid or the like is used as a catalyst, the mixture may be neutralized with an alkali metal such as sodium hydroxide or potassium hydroxide before proceeding to the extraction step. In the extraction step, an aromatic hydrocarbon solvent such as toluene or xylene may be used alone, or a non-aromatic hydrocarbon such as cyclohexane or toluene may be used in combination. After extraction, the organic layer is washed with water until the wastewater becomes neutral, and the solvent and the excess compound having a (2-bromoethyl)benzene structure are distilled off using an evaporator or the like, thereby obtaining a compound having at least two or more 2-bromoethylethylbenzene structures in the target molecule.

Examples of compounds having a (2-bromoethyl)benzene structure include, but are not limited to, (2-bromoethyl)benzene, 1-(2-bromoethyl)-2-methylbenzene, 1-(2-bromoethyl)-3-methylbenzene, 1-(2-bromoethyl)-4-methylbenzene, 1-(2-bromoethyl)-2,3-dimethylbenzene, 1-(2-bromoethyl)-2,4-dimethylbenzene, 1-(2-bromoethyl)-2,5-dimethylbenzene, and 1-(2-bromoethyl)-2,6-dimethylbenzene. These may be used alone or in combination of two or more. A large carbon number improves solvent solubility, but reduces heat resistance, so it is preferably unsubstituted or substituted with an alkyl group having 1 to 3 carbon atoms, more preferably unsubstituted or substituted with an alkyl group having 1 to 2 carbon atoms, and most preferably unsubstituted or substituted with a methyl group.

Examples of bishalogenated methylaryl compounds include, but are not limited to, o-xylylene difluoride, m-xylylene difluoride, p-xylylene difluoride, o-xylylene dichloride, m-xylylene dichloride, p-xylylene dichloride, o-xylylene dibromide, m-xylylene dibromide, p-xylylene dibromide, o-xylylene diiodide, m-xylylene diiodide, and p-xylylene diiodide. These compounds may be used alone or in combination of two or more. From the viewpoint of the reactivity of the raw materials during synthesis, chloride-based compounds, bromide-based compounds, and iodide-based compounds are preferred, and chloride-based compounds and bromide-based compounds are more preferred.

Examples of bishydroxymethylaryl compounds include, but are not limited to, o-benzenedimethanol, m-benzenedimethanol, p-benzenedimethanol, etc. These may be used alone or in combination of two or more. The amount of these compounds used is preferably 0.05 to 0.8 parts by weight, more preferably 0.1 to 0.6 parts by weight, per part by weight of the compound having a (2-bromoethyl)benzene structure.

In the reaction of a compound having a (2-bromoethyl)benzene structure with a halogenated methylaryl compound or the like, as well as hydrochloric acid, phosphoric acid, sulfuric acid, formic acid, p-toluenesulfonic acid, methanesulfonic acid, Lewis acids such as aluminum chloride and zinc chloride, activated clay, acidic clay, white carbon, zeolite, silica-alumina, and the like, and acidic ion exchange resins can be used as catalysts as necessary. These can be used alone or in combination of two or more. The amount of catalyst used is 0.05 to 0.8 mol, preferably 0.1 to 0.7 mol, per mol of the compound having a (2-bromoethyl)benzene structure used. If the amount of catalyst used is too large, the viscosity of the reaction solution may be too high, making stirring difficult, and if the amount is too small, the reaction may proceed slowly. The reaction may be carried out using an organic solvent such as hexane, cyclohexane, octane, toluene, or xylene, as necessary, or may be carried out without a solvent. For example, after adding an acidic catalyst to a mixed solution of a compound having a (2-bromoethyl)benzene structure, a halogenated methylaryl compound, and a solvent, if the catalyst contains water, the water is removed from the system by azeotropy. Thereafter, the reaction is carried out at 40° C. to 180° C., preferably 50° C. to 170° C., for 0.5 to 20 hours. After the reaction is completed, the acidic catalyst may be neutralized with an alkaline aqueous solution, but it is also possible to proceed to the water washing step without neutralizing it. In the water washing step, a water-insoluble organic solvent is added to the oil layer and water washing is repeated until the wastewater becomes neutral.

The softening point of the compound represented by formula (2) is preferably 80° C. or less, more preferably 70° C. or less. When the softening point is 80° C. or less, the viscosity when induced into the compound represented by formula (1) is low. This makes it easy to ensure fluidity, does not impregnate glass cloth or carbon fiber, and facilitates B-stage formation such as prepreg formation. If the viscosity is reduced by increasing the dilution solvent, there is a possibility that the resin will not sufficiently adhere to the fibrous material in the impregnation process.

[Maleimide Compound Having a Maleimide Equivalent of 450 g/Eq. Or More and 2000 g/Eq. Or Less]

Any maleimide compound having a maleimide equivalent of 450 g/eq. or more and 2000 g/eq. or less may be used as the maleimide compound having a maleimide equivalent of 450 g/eq. or more and 2000 g/eq. or less. By using such a maleimide compound, a cured product exhibiting low water absorption and low dielectric tangent can be obtained.

In the present invention, the maleimide equivalent is the weight of a compound containing one equivalent of a maleimide group, and for example, if one maleimide group is attached to a maleimide compound having a molecular weight of 450, the maleimide equivalent is 450 g/eq. The maleimide equivalent can be measured, for example, by the measurement method described in JP 2020-187012 A. In addition, when the maleimide equivalent can be calculated from the structural formula and the number of functional groups, that value may be used.

Although maleimide compounds have excellent heat resistance, they have two carbonyl groups and a nitrogen atom, and are functional groups that are prone to water absorption due to their high polarity. Therefore, they tend to absorb water in humid environments and have poor dielectric properties. Therefore, the lower limit of the maleimide equivalent is preferably 450 g/eq., and more preferably 500 g/eq. In addition, when the maleimide equivalent is large, the crosslink density decreases, which may lead to a decrease in heat resistance, so the upper limit of the maleimide equivalent is preferably 2000 g/eq., more preferably 1500 g/eq., and particularly preferably 1200 g/eq.

The maleimide compound preferably has two or more maleimide groups in the molecule. In addition, it is preferable that the maleimide compound has a polystyrene structure in the molecule. As the maleimide compound having a polystyrene structure in the molecule, any known compound may be used. For example, compounds having a polystyrene structure in the molecule described in Japanese Patent No. 7208705, Japanese Patent No. 7182343, Japanese Patent Publication No. 2022-176111, Japanese Patent No. 7219654, S. Ramesh et al./Composites Part B 75 (2015) 167e175 etc. can be mentioned.

The compound represented by formula (1) is preferably 1 to 1000 parts by weight, more preferably 10 to 750 parts by weight, even more preferably 20 to 500 parts by weight, and most preferably 30 to 300 parts by weight, relative to 100 parts by weight of the maleimide compound. If it is less than 1 part by weight, the low water absorption of the compound represented by formula (1) may not be fully reflected in the properties of the cured product, and if it exceeds 1000 parts by weight, the crosslink density increases and cure shrinkage becomes too large, so that adhesion may decrease or the flexibility of the cured film may be lost.

In addition to the compound represented by formula (1) and the maleimide compound having a maleimide equivalent of 450 g/eq. or more, various materials may be added to the curable resin composition of the present embodiment to improve performance.

### [Curing Accelerator]

The curing property of the curable resin composition of the present embodiment can be improved by adding a curing accelerator. As the curing accelerator, an anionic curing accelerator that accelerates the curing reaction by generating anions upon irradiation with ultraviolet light or visible light or heating, or a cationic curing accelerator that accelerates the curing reaction by generating cations upon irradiation with ultraviolet light or visible light or heating, is preferable.

Examples of the anionic curing accelerator include imidazoles such as 2-methylimidazole, 2-ethylimidazole, and 2-ethyl-4-methylimidazole, trialkylamines such as triethylamine and tributylamine, 4-dimethylaminopyridine, benzyldimethylamine, 2,4,6,-tris(dimethylaminomethyl) phenol, and 1,8-diazabicyclo(5,4,0)-undecene, with 4-dimethylaminopyridine and 1,8-diazabicyclo(5,4,0)-undecene being preferred. Other examples include phosphines such as triphenylphosphine, quaternary ammonium salts such as tetrabutylammonium salts, triisopropylmethylammonium salts, trimethyldecanylammonium salts, cetyltrimethylammonium salts, and hexadecyltrimethylammonium hydroxide, but are not limited thereto. These may be used alone or in combination.

Examples of the cationic curing accelerator include quaternary phosphonium salts such as triphenylbenzylphosphonium salt, triphenylethylphosphonium salt, and tetrabutylphosphonium salt (the counter ion of the quaternary salt may be a halogen, an organic acid ion, a hydroxide ion, or the like, and is not particularly specified, but an organic acid ion or a hydroxide ion is particularly preferred); transition metal compounds (transition metal salts) such as tin octylate, zinc carboxylate (zinc 2-ethylhexanoate, zinc stearate, zinc behenate, zinc myristate), and zinc phosphate ester (zinc octylphosphate, zinc stearylphosphate), but are not limited thereto. Furthermore, these may be used alone or in combination.

The amount of the curing accelerator to be added is 0.01 to 5.0 parts by weight based on 100 parts by weight of the curable resin composition, as required.

### [Inorganic Filler]

The curable resin composition of the present embodiment may contain an inorganic filler. Examples of inorganic fillers include powders such as fused silica, crystalline silica, porous silica, alumina, zircon, calcium silicate, calcium carbonate, quartz powder, silicon carbide, silicon nitride, boron nitride, zirconia, aluminum nitride, graphite, forsterite, steatite, spinel, mullite, titania, talc, clay, iron oxide asbestos, and glass powder, and inorganic fillers obtained by making these into a spherical or crushed shape, but are not limited thereto. In addition, these may be used alone or in combination.

When a curable resin composition for semiconductor encapsulation is obtained, the amount of the inorganic filler used is preferably 80 to 92 parts by weight, and more preferably 83 to 90 parts by weight, based on 100 parts by weight of the curable resin composition. When a curable resin composition for interlayer insulating layer forming materials, copper-clad laminates, prepregs, RCCs, and other substrate materials is obtained, the amount of the inorganic filler used is preferably 5 to 80 parts by weight, and more preferably 10 to 60 parts by weight, based on 100 parts by weight of the curable resin composition.

### [Polymerization Initiator]

The curable resin composition of the present embodiment can also improve the curability by adding a polymerization initiator. The polymerization initiator is a compound capable of polymerizing an olefin functional group such as an ethylenically unsaturated bond, and examples of the polymerization initiator include an olefin metathesis polymerization initiator, an anionic polymerization initiator, a cationic polymerization initiator, and a radical polymerization initiator. Among these, it is preferable to use a radical polymerization initiator having curability and moderate stability. The radical polymerization initiator is a compound that generates radicals by irradiation with ultraviolet light or visible light or by heating, and starts a chain polymerization reaction. Examples of radical polymerization initiators that can be used include organic peroxides, azo compounds, and benzopinacoles, and it is preferable to use an organic peroxide because it has little effect on curing temperature control, outgassing suppression, and electrical properties of decomposition products.

Examples of the organic peroxides include, but are not limited to: ketone peroxides such as methyl ethyl ketone peroxide and acetylacetone peroxide; diacyl peroxides such as benzoyl peroxide; dialkyl peroxides such as dicumyl peroxide and 1,3-bis-(t-butylperoxyisopropyl)-benzene; peroxyketals such as t-butylperoxybenzoate and 1,1-di-t-butylperoxycyclohexane; alkyl peresters such as α-cumylperoxyneodecanoate, t-butylperoxyneodecanoate, t-butylperoxypivalate, 1,1,3,3-tetramethylbutylperoxy-2-ethylhexanoate, t-amylperoxy-2-ethylhexanoate, t-butylperoxy-2-ethylhexanoate, t-amylperoxy-3,5,5-torimethylhexanoate, t-butylperoxy-3,5,5-trimethylhexanoate, t-amylperoxy benzoate; peroxy carbonates such as di-2-ethylhexyl peroxydicarbonate, bis(4-t-butylcyclohexyl)peroxydicarbonate, t-butylperoxyisopropyl carbonate, 1,6-bis(t-butylperoxycarbonyloxy)hexane; t-butyl hydroperoxide, cumene hydroperoxide, t-butyl peroxyoctoate, lauroyl peroxide, etc. These may be used alone or in combination. Among the above organic peroxides, ketone peroxides, diacyl peroxides, hydroperoxides, dialkyl peroxides, peroxyketals, alkyl peresters, peroxycarbonates, etc. are preferred, and dialkyl peroxides are more preferred.

Examples of the azo-based compound include, but are not limited to, azobisisobutyronitrile, 4,4′-azobis(4-cyanovaleric acid), 2,2′-azobis(2,4-dimethylvaleronitrile), etc. These may be used alone or in combination.

The amount of the polymerization initiator added is preferably 0.01 to 5 parts by weight, particularly preferably 0.01 to 3 parts by weight, in 100 parts by weight of the curable resin composition. If the amount of the polymerization initiator used is less than 0.01 part by weight, the molecular weight may not be sufficiently extended during the polymerization reaction, and if it is more than 5 parts by weight, the dielectric properties such as the dielectric constant and the dielectric loss tangent may be impaired.

### [Polymerization Inhibitor]

The curable resin composition of the present embodiment may contain a polymerization inhibitor. By containing a polymerization inhibitor, storage stability is improved and the reaction initiation temperature can be controlled. By controlling the reaction initiation temperature, it becomes easy to ensure fluidity, impregnation into glass cloth and the like is not impaired, and B-stage such as prepreg formation is facilitated. If the polymerization reaction proceeds too much during prepreg formation, problems such as difficulty in lamination during the lamination process are likely to occur.

The polymerization inhibitor may be added during or after the synthesis of the compound represented by formula (1) or the maleimide compound having a maleimide equivalent of 450 g/eq. or more and 2000 g/eq. or less. The amount of the polymerization inhibitor used is 0.008 to 1 part by weight, preferably 0.01 to 0.5 parts by weight, based on 100 parts by weight of the compound of this embodiment.

Examples of the polymerization inhibitor include phenol-based, sulfur-based, phosphorus-based, hindered amine-based, nitroso-based, and nitroxyl radical-based. The polymerization inhibitor may be used alone or in combination. Among these, in the present embodiment, the phenol-based, hindered amine-based, nitroso-based, and nitroxyl radical-based are preferred.

Examples of the phenol-based polymerization inhibitor include: monophenols such as 2,6-di-t-butyl-p-cresol, butylated hydroxyanisole, 2,6-di-t-butyl-p-ethylphenol, stearyl-β-(3,5-di-t-butyl-4-hydroxyphenyl)propionate, isooctyl-3-(3,5-di-t-butyl-4-hydroxyphenyl)propionate, 2,4-bis-(n-octylthio)-6-(4-hydroxy-3,5-di-t-butylanilino)-1,3,5-triazine, and 2,4-bis[(octylthio)methyl]-o-cresol; bisphenols such as 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol), triethylene glycol-bis[3-(3-t-butyl-5-methyl-4-hydroxyphenyl)propionate], 1,6-hexanediol-bis[3-(3,5-di-t-butyl-4-hydroxyphenyl)propionate], N,N′-hexamethylenebis(3,5-di-t-butyl-4-hydroxy-hydrocinnamamide), 2,2-thio-diethylenebis[3-(3,5-di-t-butyl-4-hydroxyphenyl)propionate, 3,5-di-t-butyl-4-hydroxybenzylphosphonate-diethyl ester, 3,9-bis[1,1-dimethyl-2-{β-(3-t-butyl-4-hydroxy-5-methylphenyl) propionyloxy}ethyl]2,4,8,10-tetraoxaspiro[5,5]undecane, bis(3,5-di-t-butyl-4-hydroxybenzylsulfonate ethyl) calcium; polymeric phenols such as 1,1,3-tris(2-methyl-4-hydroxy-5-t-butylphenyl) butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis-(4′-hydroxy-3′-t-butylphenyl) butyric acid]glycol ester, tris-(3,5-di-t-butyl-4-hydroxybenzyl)-isocyanurate, 1,3,5-tris(3′,5′-di-t-butyl-4′-hydroxybenzyl)-S-triazine-2,4,6-(1H,3H,5H)trione, and tocopherol, but are not limited thereto.

Examples of the sulfur-based polymerization inhibitor include, but are not limited to, dilauryl-3,3′-thiodipropionate, dimyristyl-3,3′-thiodipropionate, and distearyl-3,3′-thiodipropionate.

Examples of the phosphorus-based polymerization inhibitor include: phosphites such as triphenyl phosphite, diphenyl isodecyl phosphite, phenyl diisodecyl phosphite, tris(nonylphenyl) phosphite, diisodecyl pentaerythritol phosphite, tris(2,4-di-t-butylphenyl) phosphite, cyclic neopentane tetrayl bis(octadecyl)phosphite, cyclic neopentane tetrayl bis(2,4-di-t-butylphenyl) phosphite, cyclic neopentane tetrayl bis(2,4-di-t-butyl-4-methylphenyl) phosphite, bis[2-t-butyl-6-methyl-4-{2-(octadecyloxycarbonyl)ethyl}phenyl]hydrogen phosphite; and oxaphosphaphenanthrene oxides such as 9,10-dihydro-9-oxa-10-phosphaphenanthrene-10-oxide, 10-(3,5-di-t-butyl-4-hydroxybenzyl)-9,10-dihydro-9-oxa-10-phosphaphenanthrene-10-oxide, and 10-decyloxy-9,10-dihydro-9-oxa-10-phosphaphenanthrene-10-oxide, but are not limited thereto.

Examples of the hindered amine-based polymerization inhibitor include, but are not limited to: ADK STAB (registered trademark) LA-40MP, ADK STAB LA-40Si, ADK STAB LA-402AF, ADK STAB LA-87, ADK STAB LA-82, ADK STAB LA-81, ADK STAB LA-77Y, ADK STAB LA-77G, ADK STAB LA-72, ADK STAB LA-68, ADK STAB LA-63P, ADK STAB LA-57, ADK STAB LA-52 (all manufactured by ADE Corporation); and

Chimassorb (registered trademark) 2020FDL, Chimassorb 944FDL, Chimassorb 944LD, Tinuvin (registered trademark) 622SF, Tinuvin PA144, Tinuvin 765, Tinuvin 770DF, Tinuvin XT55FB, Tinuvin 111FDL, Tinuvin 783FDL, and Tinuvin 791FB (all manufactured by BASF Corporation).

Examples of the nitroso-based polymerization inhibitor include, but are not limited to: p-nitrosophenol, N-nitrosodiphenylamine, and the ammonium salt of N-nitrosophenylhydroxyamine (cupferron), etc. Among these, the ammonium salt of N-nitrosophenylhydroxyamine (cupferron) is preferred.

Examples of the nitroxyl radical polymerization inhibitor include di-tert-butyl nitroxide, 2,2,6,6-tetramethylpiperidine-1-oxyl, 4-hydroxy-2,2,6,6-tetramethylpiperidine-1-oxyl, 4-oxo-2,2,6,6-tetramethylpiperidine-1-oxyl, 4-amino-2,2,6,6-tetramethylpiperidine-1-oxyl, 4-methoxy-2,2,6,6-tetramethylpiperidine-1-oxyl, 4-acetoxy-2,2,6,6-tetramethylpiperidine-1-oxyl, 4-benzoyloxy-2,2,6,6-tetramethylpiperidine-1-oxyl, and the like, but are not limited thereto.

### [Flame Retardant]

The curable resin composition of the present embodiment may contain a flame retardant. Examples of the flame retardant include halogen-based flame retardants, inorganic flame retardants (antimony compounds, metal hydroxides, nitrogen compounds, boron compounds, etc.), and phosphorus-based flame retardants. From the viewpoint of achieving halogen-free flame retardancy, phosphorus-based flame retardants are preferred.

The phosphorus-based flame retardant may be either a reactive type or an additive type. Specific examples include: phosphoric acid esters such as trimethyl phosphate, triethyl phosphate, tricresyl phosphate, trixylyleneyl phosphate, cresyl diphenyl phosphate, cresyl-2,6-dixylyleneyl phosphate, 1,3-phenylene bis(dixylyleneyl phosphate), 1,4-phenylene bis(dixylyleneyl phosphate), and 4,4′-biphenyl(dixylyleneyl phosphate); phosphanes such as 9,10-dihydro-9-oxa-10-phosphaphenanthrene-10-oxide and 10-(2,5-dihydroxyphenyl)-10H-9-oxa-10-phosphaphenanthrene-10-oxide; as well as phosphorus-containing epoxy compounds obtained by reacting an epoxy resin with the active hydrogen of the phosphanes, red phosphorus, and the like, but are not limited thereto. These may be used alone or in combination. Of the above-listed substances, phosphates, phosphanes, or phosphorus-containing epoxy compounds are preferred, with 1,3-phenylenebis(dixylilenyl phosphate), 1,4-phenylenebis(dixylilenyl phosphate), 4,4′-biphenyl(dixylilenyl phosphate) or phosphorus-containing epoxy compounds being particularly preferred.

The content of the flame retardant is preferably in the range of 0.1 to 0.6 parts by weight per 100 parts by weight of the curable resin composition. If the content is less than 0.1 part by weight, the flame retardancy may be insufficient, and if the content is more than 0.6 part by weight, the moisture absorption and dielectric properties of the cured product may be adversely affected.

### [Light Stabilizer]

The curable resin composition of the present embodiment may contain a light stabilizer. As the light stabilizer, a hindered amine light stabilizer (Hindered Amine Light Stabilizers, HALS) or the like is preferable. Examples of HALS include reaction products of dibutylamine, 1,3,5-triazine, N,N′-bis(2,2,6,6-tetramethyl-4-piperidyl-1,6-hexamethylenediamine and N-(2,2,6,6-tetramethyl-4-piperidyl)butylamine, reaction products of dimethyl succinate-1-(2-hydroxyethyl)-4-hydroxy-2,2,6,6-tetramethylpiperidine, poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], bis(1,2,2,6,6-pentamethyl-4-piperidyl) [[3,5-bis(1,1-dimethylethyl)-4-hydroxyphenyl]methyl]butyl malonate, bis(2,2,6,6-tetramethyl-4-piperidyl) sebacate, bis(1,2,2,6,6-pentamethyl-4-piperidyl) sebacate, bis(1-octyloxy-2,2,6,6-tetramethyl-4-piperidyl) sebacate, 2-(3,5-di-t-butyl-4-hydroxybenzyl)-2-n-butylmalonate bis(1,2,2,6,6-pentamethyl-4-piperidyl), and the like, but are not limited thereto. These may be used alone or in combination.

The content of the light stabilizer is preferably in the range of 0.001 to 0.1 parts by weight per 100 parts by weight of the curable resin composition. If the content is less than 0.001 part by weight, the light stabilizing effect may be insufficient, and if the content is more than 0.1 part by weight, the moisture absorption and dielectric properties of the cured product may be adversely affected.

### [Binder Resin]

The curable resin composition of the present embodiment may use a binder resin. Examples of binder resins include, but are not limited to, butyral resins, acetal resins, acrylic resins, epoxy-nylon resins, NBR-phenolic resins, epoxy-NBR resins, and silicone resins. These may be used alone or in combination.

The amount of the binder resin is preferably within a range that does not impair the flame retardancy and heat resistance of the cured product, and is preferably 0.05 to 50 parts by weight, and more preferably 0.05 to 20 parts by weight, per 100 parts by weight of the curable resin composition, as needed.

### [Additives]

The curable resin composition of the present embodiment may contain additives. Examples of the additive includes: modified acrylonitrile copolymers, polyethylene, fluororesins, silicone gels, silicone oils, surface treatment agents for fillers such as silane coupling agents, release agents, and colorants such as carbon black, phthalocyanine blue, and phthalocyanine green.

The amount of the additive is preferably 30 parts by mass or less, more preferably 20 parts by mass or less, and particularly preferably 10 parts by mass or less, based on 100 parts by mass of the curable resin composition.

The curable resin composition of the present embodiment may further include epoxy resins, active ester compounds, phenolic resins, polyphenylene ether compounds, amine resins, compounds having ethylenically unsaturated bonds, isocyanate resins, polyamide resins, maleimide compounds other than the maleimide compounds having a maleimide equivalent of 450 g/eq. or more and 2000 g/eq. or less, cyanate ester resins, polyimide resins, polybutadiene and modified products thereof, polystyrene and modified products thereof, polyethylene and modified products thereof, etc., which may be used alone or in combination. Of these compounds, it is preferable to contain maleimide compounds, polyphenylene ether compounds, compounds having ethylenically unsaturated bonds, cyanate ester resins, polybutadiene and modified products thereof, polystyrene and modified products thereof, and polyethylene and modified products thereof, in view of the balance of heat resistance, adhesion, and dielectric properties. By containing these compounds, the brittleness of the cured product can be improved and adhesion to metals can be improved, and cracks in the package during reliability tests such as solder reflow and thermal cycles can be suppressed. The total amount of the above compounds used is preferably 10 times by weight or less, more preferably 5 times by weight or less, and particularly preferably 3 times by weight or less, relative to the compound represented by formula (1), unless otherwise specified. The preferred lower limit is 0.1 times by weight or more, more preferably 0.25 times by weight or more, and even more preferably 0.5 times by weight or more. Within the above range, the effect of each compound added can be added while taking advantage of the effect of the low dielectric characteristic (low dielectric tangent) of the compound of this embodiment. As for these components, the following examples can be used.

### [Epoxy Resin]

Preferred examples of the epoxy resin are shown below, but are not limited to these. The epoxy resin may be liquid or solid, and may be used alone or in combination.

Examples of liquid epoxy resins include bisphenol A type epoxy resins, bisphenol F type epoxy resins, bisphenol AF type epoxy resins, naphthalene type epoxy resins, glycidyl ester type epoxy resins, glycidyl amine type epoxy resins, phenol novolac type epoxy resins, alicyclic epoxy resins having an ester skeleton, cyclohexane type epoxy resins, cyclohexane dimethanol type epoxy resins, glycidyl amine type epoxy resins, and epoxy resins having a butadiene structure. Specific examples include “RE310S”, “RE410S” (all manufactured by Nippon Kayaku Co., Ltd., bisphenol A type epoxy resin), “RE303S”, “RE304S”, “RE403S”, “RE404S” (all manufactured by Nippon Kayaku Co., Ltd., bisphenol F type epoxy resin), “HP4032”, “HP4032D”, “HP4032SS” (all manufactured by DIC Corporation, naphthalene type epoxy resin), “828US”, “jER828EL”, “825”, “828EL” (all manufactured by Mitsubishi Chemical Corporation, bisphenol A type epoxy resin), “jE807”, “1750” (all manufactured by Mitsubishi Chemical Corporation, bisphenol F type epoxy resin), “jER152” (manufactured by Mitsubishi Chemical Corporation, phenol novolac type epoxy resin), “630”, “630LSD” (all manufactured by Mitsubishi Chemical Corporation, glycidylamine type epoxy resin), “ZX1059” (manufactured by Nippon Steel & Sumitomo Metal Chemical Co., Ltd., a mixture of bisphenol A type epoxy resin and bisphenol F type epoxy resin), “EX-721” (manufactured by Nagase ChemteX Corporation, glycidyl ester type epoxy resin), “Celloxide (registered trademark) 2021P” (manufactured by Daicel Corporation, alicyclic epoxy resin having an ester skeleton), “PB-3600” (manufactured by Daicel Corporation, epoxy resin having a butadiene structure), “ZX1658”, “ZX1658GS” (all manufactured by Nippon Steel & Sumitomo Metal Chemical Co., Ltd., liquid 1,4-glycidylcyclohexane type epoxy resin), and the like. These may be used alone or in combination of two or more.

Examples of solid epoxy resins include bixylenol type epoxy resins, naphthalene type epoxy resins, naphthalene type tetrafunctional epoxy resins, cresol novolac type epoxy resins, dicyclopentadiene type epoxy resins, trisphenol type epoxy resins, naphthol type epoxy resins, biphenyl type epoxy resins, naphthylene ether type epoxy resins, anthracene type epoxy resins, bisphenol A type epoxy resins, bisphenol AF type epoxy resins, and tetraphenylethane type epoxy resins, and preferred examples include naphthol type epoxy resins, bisphenol AF type epoxy resins, naphthalene type epoxy resins, and biphenyl type epoxy resins. Specific examples include “HP4032H” (DIC Corporation, naphthalene type epoxy resin), “HP-4700”, and “HP-4710” (DIC Corporation, naphthalene type tetrafunctional epoxy resin), “N-690” (DIC Corporation, cresol novolac type epoxy resin), “N-695” (DIC Corporation, cresol novolac type epoxy resin), “HP-7200”, “HP-7200HH”, and “HP-7200H” (DIC Corporation, dicyclopentadiene type epoxy resin)., “EXA-7311”, “EXA-7311-G3”, “EXA-7311-G4”, “EXA-7311-G4S”, “HP-6000” (all manufactured by DIC Corporation, naphthylene ether type epoxy resin), “EPPN-502H” (manufactured by Nippon Kayaku Co., Ltd., trisphenol type epoxy resin), “NC-7000L”, “NC-7300” (all manufactured by Nippon Kayaku Co., Ltd., naphthol-cresol novolac type epoxy resin), “NC-3000H”, “NC-3000”, “NC-3000L”, “NC-3100” (all manufactured by Nippon Kayaku Co., Ltd., biphenyl aralkyl type epoxy resin), “XD-1000-2L”, “XD-1000-L”, “XD-1000-H” (all manufactured by Nippon Kayaku Co., Ltd., dicyclopentadiene type epoxy resin), “ESN475V” (manufactured by Nippon Steel & Sumikin Chemical Co., Ltd., naphthol type epoxy resin), “ESN485” (manufactured by Nippon Steel & Sumikin Chemical Co., Ltd., naphthol novolac type epoxy resin), “YX-4000H”, “YX-4000”, “YL6121” (all manufactured by Mitsubishi Chemical Corporation, biphenyl type epoxy resin), “YX-4000HK” (manufactured by Mitsubishi Chemical Corporation, bixylenol type epoxy resin), “YX-8800” (manufactured by Mitsubishi Chemical Corporation, anthracene type epoxy resin), “PG-100”, “CG-500” (manufactured by Osaka Gas Chemical Co., Ltd., fluorene type epoxy resin), “YL-7760” (manufactured by Mitsubishi Chemical Corporation, bisphenol AF type epoxy resin), “YL-7800” (manufactured by Mitsubishi Chemical Corporation, fluorene type epoxy resin), “jER (registered trademark) 1010” (manufactured by Mitsubishi Chemical Corporation, solid bisphenol A type epoxy resin), “jER1031S” (manufactured by Mitsubishi Chemical Corporation, tetraphenylethane type epoxy resin), etc. These may be used alone or in combination of two or more.

### [Active Ester Compound]

The active ester compound refers to a compound that contains at least one ester bond in the structure and has an aliphatic chain, an aliphatic ring, or an aromatic ring bonded to both sides of the ester bond. Examples of the active ester compound include compounds having two or more highly reactive ester groups in one molecule, such as phenol esters, thiophenol esters, N-hydroxyamine esters, and esters of heterocyclic hydroxy compounds, and are obtained by a condensation reaction between at least one compound of a carboxylic acid compound, an acid chloride, or a thiocarboxylic acid compound and at least one compound of a hydroxy compound or a thiol compound. In particular, from the viewpoint of improving heat resistance, it is preferable to obtain the active ester compound from a carboxylic acid compound or an acid chloride and a hydroxy compound, and the hydroxy compound is preferably a phenol compound or a naphthol compound. The active ester compound may be used alone or in combination of two or more types.

Examples of the carboxylic acid compound include benzoic acid, acetic acid, succinic acid, maleic acid, itaconic acid, phthalic acid, isophthalic acid, terephthalic acid, and pyromellitic acid.

Examples of the acid chloride include acetyl chloride, acrylic acid chloride, methacrylic acid chloride, malonyl chloride, succinic acid dichloride, diglycolyl chloride, glutaric acid dichloride, suberic acid dichloride, sebacic acid dichloride, adipic acid dichloride, dodecandioyl dichloride, azelaic acid chloride, 2,5-furandicarbonyl dichloride, phthaloyl chloride, isophthaloyl chloride, terephthaloyl chloride, trimesic acid chloride, bis(4-chlorocarbonylphenyl) ether, 4,4′-diphenyldicarbonyl chloride, and 4,4′-azodibenzoyl dichloride.

Examples of the phenol compound and naphthol compound include hydroquinone, resorcin, bisphenol A, bisphenol F, bisphenol S, phenolphthaline, methylated bisphenol A, methylated bisphenol F, methylated bisphenol S, phenol, o-cresol, m-cresol, p-cresol, catechol, α-naphthol, β-naphthol, 1,5-dihydroxynaphthalene, 1,6-dihydroxynaphthalene, 2,6-dihydroxynaphthalene, dihydroxybenzophenone, trihydroxybenzophenone, tetrahydroxybenzophenone, phloroglucin, benzenetriol, dicyclopentadiene-type diphenol compound, phenol novolak, and phenolic resins described below. Here, the term “dicyclopentadiene-type diphenol compound” refers to a diphenol compound obtained by condensing one molecule of dicyclopentadiene with two molecules of phenol.

Preferred specific examples of the active ester compound include an active ester compound containing a dicyclopentadiene-type diphenol structure, an active ester compound containing a naphthalene structure, an active ester compound containing an acetylated product of phenol novolac, an active ester compound containing a benzoylated product of phenol novolac, a compound described in Example 2 of WO 2020/095829, and a compound disclosed in WO 2020/059625. Among them, an active ester compound containing a naphthalene structure and an active ester compound containing a dicyclopentadiene-type diphenol structure are more preferred. The dicyclopentadiene-type diphenol structure refers to a divalent structural unit consisting of phenylene-dicyclopentylene-phenylene.

Commercially available active ester compounds include, for example: active ester compounds containing a dicyclopentadiene-type diphenol structure such as “EXB9451”, “EXB9460”, “EXB9460S”, “HPC-8000-65T”, “HPC-8000H-65TM”, “EXB-8000L-65TM”, and “EXB-8150-65T” (manufactured by DIC Corporation); active ester compounds containing a naphthalene structure such as “EXB9416-70BK” (manufactured by DIC Corporation); active ester compounds containing an acetylated phenol novolac such as “DC808” (manufactured by Mitsubishi Chemical Corporation); active ester compounds containing a benzoylated phenol novolac such as “YLH1026”, “YLH1030”, and “YLH1048” (manufactured by Mitsubishi Chemical Corporation); an active ester curing agent which is an acetylated phenol novolac such as “DC808” (manufactured by Mitsubishi Chemical Corporation), and an active ester curing agent containing a phosphorus atom such as “EXB-9050L-62M” (manufactured by DIC Corporation).

Regarding the compounding ratio of the active ester compound and the epoxy resin, the ratio (a/B) of the active ester equivalent (a) to the epoxy equivalent (B) is preferably 0.5 to 1.5, more preferably 0.8 to 1.2, and even more preferably 0.90 to 1.10. If it is out of the above range, there is a risk that excess epoxy groups or active ester groups will remain in the system, and the characteristics may deteriorate in a high-temperature storage test (e.g., 150° C., 1000 hours) or a long-term reliability test under high-temperature and high-humidity conditions (e.g., temperature: 85° C., humidity: 85%).

### [Phenolic Resin]

Phenolic resin is a compound having two or more phenolic hydroxy groups in the molecule. Examples of phenolic resin include, but are not limited to, reaction products of phenols and aldehydes, reaction products of phenols and diene compounds, reaction products of phenols and ketones, reaction products of phenols and substituted biphenyls, reaction products of phenols and substituted phenyls, reaction products of bisphenols and aldehydes, etc. Furthermore, these may be used alone or in combination.

Specific examples of the above raw materials are shown below, but are not limited to these.

### <Phenols>

Phenol, alkyl-substituted phenol, aromatic-substituted phenol, hydroquinone, resorcin, naphthol, alkyl-substituted naphthol, dihydroxybenzene, alkyl-substituted dihydroxybenzene, dihydroxynaphthalene, etc.

### <Aldehydes>

Formaldehyde, acetaldehyde, alkyl aldehyde, benzaldehyde, alkyl-substituted benzaldehyde, hydroxybenzaldehyde, naphthaldehyde, glutaraldehyde, phthalaldehyde, crotonaldehyde, cinnamaldehyde, furfural, etc.

### <Diene Compounds>

Dicyclopentadiene, terpenes, vinylcyclohexene, norbornadiene, vinylnorbornene, tetrahydroindene, divinylbenzene, divinylbiphenyl, diisopropenylbiphenyl, butadiene, isoprene, etc.

### <Ketones>

Acetone, methyl ethyl ketone, methyl isobutyl ketone, acetophenone, benzophenone, fluorenone, etc.

### <Substituted Biphenyls>

4,4′-bis(chloromethyl)-1,1′-biphenyl, 4,4′-bis(methoxymethyl)-1,1′-biphenyl, 4,4′-bis(hydroxymethyl)-1,1′-biphenyl, etc.

### <Substituted Phenyls>

1,4-bis(chloromethyl)benzene, 1,4-bis(methoxymethyl)benzene, 1,4-bis(hydroxymethyl)benzene, etc.

### [Polyphenylene Ether Compound]

From the viewpoint of heat resistance and electrical properties, the polyphenylene ether compound is preferably a polyphenylene ether compound having an ethylenically unsaturated bond, and more preferably a polyphenylene ether compound having an acrylic group, a methacrylic group, or a styrene structure. Commercially available products include SA-9000 (manufactured by SABIC, a polyphenylene ether compound having a methacrylic group) and OPE-2St-1200 (manufactured by Mitsubishi Gas Chemical Co., Ltd., a polyphenylene ether compound having a styrene structure).

The number average molecular weight (Mn) of the polyphenylene ether compound is preferably 500 to 5000, more preferably 2000 to 5000, and more preferably 2000 to 4000. If the molecular weight is less than 500, the heat resistance of the cured product tends to be insufficient. In addition, if the molecular weight is greater than 5000, the melt viscosity becomes high and sufficient fluidity cannot be obtained, which tends to lead to molding defects. In addition, the reactivity is also reduced, the curing reaction takes a long time, and the amount of unreacted compounds not incorporated into the curing system increases, which leads to a decrease in the glass transition temperature of the cured product and a decrease in the heat resistance of the cured product.

If the number average molecular weight of the polyphenylene ether compound is 500 to 5000, excellent heat resistance and moldability can be achieved while maintaining excellent dielectric properties. The number average molecular weight here can be specifically measured using gel permeation chromatography or the like.

The polyphenylene ether compound may be one obtained by a polymerization reaction, or one obtained by a redistribution reaction of a high molecular weight polyphenylene ether compound having a number average molecular weight of about 10,000 to 30,000. In addition, these may be used as raw materials and reacted with a compound having an ethylenically unsaturated bond, such as methacryl chloride, acrylic chloride, or chloromethylstyrene, to impart radical polymerizability. The polyphenylene ether compound obtained by the redistribution reaction is obtained, for example, by heating a high molecular weight polyphenylene ether compound in a solvent such as toluene in the presence of a phenolic compound and a radical initiator to cause a redistribution reaction. The polyphenylene ether compound obtained by the redistribution reaction in this way has hydroxy groups derived from a phenolic compound that contributes to curing at both ends of the molecular chain, and is therefore preferable in that it can maintain even higher heat resistance, and that functional groups can be introduced at both ends of the molecular chain even after modification with a compound having an ethylenically unsaturated bond. In addition, the polyphenylene ether compound obtained by the polymerization reaction is preferable in that it exhibits excellent fluidity.

The molecular weight of the polyphenylene ether compound can be adjusted by adjusting the polymerization conditions, etc., in the case of a polyphenylene ether compound obtained by a polymerization reaction. In addition, in the case of a polyphenylene ether compound obtained by a redistribution reaction, the molecular weight of the obtained polyphenylene ether compound can be adjusted by adjusting the conditions, etc., of the redistribution reaction. More specifically, it is possible to adjust the amount of the phenolic compound used in the redistribution reaction. That is, the greater the amount of the phenolic compound, the lower the molecular weight of the obtained polyphenylene ether compound. In this case, poly(2,6-dimethyl-1,4-phenylene ether) or the like can be used as the high molecular weight polyphenylene ether compound that undergoes the redistribution reaction. In addition, the phenolic compound used in the redistribution reaction is not particularly limited, but for example, a polyfunctional phenolic compound having two or more phenolic hydroxy groups in the molecule, such as bisphenol A, phenol novolac, cresol novolac, etc., is preferably used. These may be used alone or in combination of two or more.

### [Amine Resin]

Amine resin is a compound having two or more amino groups in the molecule.

Examples of amine resins include, but are not limited to, diaminodiphenylmethane, diaminodiphenylsulfone, isophoronediamine, naphthalenediamine, aniline novolak (a reaction product of aniline and formalin), N-methylaniline novolak (a reaction product of N-methylaniline and formalin), orthoethylaniline novolak (a reaction product of orthoethylaniline and formalin), a reaction product of 2-methylaniline and formalin, a reaction product of 2,6-diisopropylaniline and formalin, a reaction product of 2,6-diethylaniline and formalin, a reaction product of 2-ethyl-6-ethylaniline and formalin, a reaction product of 2,6-dimethylaniline and formalin, and a reaction product obtained by reacting aniline and xylylene chloride; a reaction product of the aniline resin disclosed in Japanese Patent No. 6429862 and a substituted biphenyl such as 4,4′-bis(chloromethyl)-1,1′-biphenyl and 4,4′-bis(methoxymethyl)-1,1′-biphenyl; a reaction product of aniline and a substituted phenyl such as 1,4-bis(chloromethyl)benzene, 1,4-bis(methoxymethyl)benzene, 1,4-bis(hydroxymethyl)benzene; 4,4′-(1,3-phenylenediisopropylidene)bisaniline, 4,4′-(1,4-phenylenediisopropylidene)bisaniline; a reaction product of aniline and diisopropenylbenzene, and dimer diamine. Furthermore, these may be used alone or in combination.

### [Compound Containing an Ethylenically Unsaturated Bond]

The compound containing an ethylenically unsaturated bond is a compound that has one or more ethylenically unsaturated bonds in the molecule that can be polymerized by heat or light, regardless of whether a polymerization initiator is used or not.

Examples of the compound containing an ethylenically unsaturated bond include, but are not limited to: a reaction product of the phenolic resin with an ethylenically unsaturated bond-containing halogen-based compound such as chloromethylstyrene, allyl chloride, methallyl chloride, acrylic acid chloride, methacrylic acid chloride, etc.; a reaction product of an ethylenically unsaturated bond-containing phenol (2-allylphenol, 2-propenylphenol, 4-allylphenol, 4-propenylphenol, eugenol, isoeugenol, etc.) with a halogen-based compound (1,4-bis(chloromethyl)benzene, 4,4′-bis(chloromethyl) biphenyl, 4,4′-difluorobenzophenone, 4,4′-dichlorobenzophenone, 4,4′-dibromobenzophenone, cyanuric chloride, etc.); a reaction product of an epoxy resin or alcohol with a (meth)acrylic acid (acrylic acid, methacrylic acid, etc.), and an acid-modified product thereof. In addition, these may be used alone or in combination.

### [Isocyanate Resin]

An isocyanate resin is a compound having two or more isocyanate groups in the molecule. Examples of the isocyanate resin include aromatic diisocyanates such as p-phenylene diisocyanate, m-phenylene diisocyanate, p-xylylene diisocyanate, m-xylylene diisocyanate, 2,4-tolylene diisocyanate, 2,6-tolylene diisocyanate, 4,4′-diphenylmethane diisocyanate, and naphthalene diisocyanate; aliphatic or alicyclic diisocyanates such as isophorone diisocyanate, hexamethylene diisocyanate, 4,4′-dicyclohexylmethane diisocyanate, hydrogenated xylene diisocyanate, norbornene diisocyanate, and lysine diisocyanate; polyisocyanates such as one or more biuret forms of isocyanate monomers or isocyanate forms obtained by trimerizing the diisocyanate compounds; and polyisocyanates obtained by a urethanization reaction between the isocyanate compounds and polyol compounds, but are not limited thereto. These may be used alone or in combination.

### [Polyamide Resin]

Examples of polyamide resins include reaction products of one or more of diamines, diisocyanates, and oxazolines with dicarboxylic acids, reaction products of diamines with acid chlorides, and ring-opening polymers of lactam compounds. These may be used alone or in combination.

Specific examples of the above-mentioned raw materials are shown below, but are not limited to these.

### <Diamines>

Ethylenediamine, trimethylenediamine, tetramethylenediamine, pentamethylenediamine, hexamethylenediamine, heptamethylenediamine, octamethylenediamine, nonamethylenediamine, decanediamine, undecanediamine, dodecanediamine, tridecanediamine, tetradecanediamine, pentadecanediamine, hexadecanediamine, heptadecanediamine, octadecanediamine, nonadecanediamine, eicosanediamine, 2-methyl-1,5-diaminopentane, 2-methyl-1,8-diaminooctane, dimer diamine, cyclohexane diamine, bis-(4-aminocyclohexyl)methane, bis(3-methyl-4-aminocyclohexyl)methane, xylylene diamine, norbornane diamine, isophorone diamine, bisaminomethyltricyclodecane, phenylenediamine, diethyltoluenediamine, naphthalenediamine, diaminodiphenylmethane, bis(4-amino-3,5-dimethylphenyl)methane, bis(4-amino-3,5-diethylphenyl)methane, 4,4′-methylenebis-o-toluidine, 4,4′-methylenebis-o-ethylaniline, 4,4′-methylenebis-2-ethyl-6-methylaniline, 4,4′-methylenebis-2,6-diisopropylaniline, 4,4-ethylenedianiline, diaminodiphenyl sulfone, diaminodiphenyl ether, 1,3-bis(3-aminophenoxy)benzene, 1,3-bis(4-aminophenoxy)benzene, 4,4-bis(4-aminophenoxy) biphenyl, 2,2-bis[4-(4-aminophenoxy) biphenyl], bis[4-(4-aminophenoxy)phenyl]propane, bis[4-(4-aminophenoxy)phenyl]sulfone, 2,2-bis(3-amino-4-hydroxyphenyl)propane, 2,2-bis(4-aminophenyl)hexafluoropropane, 4,4′-(1,3-phenylenediisopropylidene)bisaniline, 4,4′-(1,4-phenylenediisopropylidene)bisaniline, 9,9-bis(4-aminophenyl) fluorene, 2,7-diaminofluorene, aminobenzylamine, diaminobenzophenone, and the like.

### <Diisocyanates>

benzene diisocyanate, toluene diisocyanate, 1,3-bis(isocyanatomethyl)benzene, 1,3-bis(isocyanatomethyl)cyclohexane, bis(4-isocyanatophenyl)methane, isophorone diisocyanate, 1,3-bis(2-isocyanato-2-propyl)benzene, 2,2-bis(4-isocyanatophenyl)hexafluoropropane, dicyclohexylmethane-4,4′-diisocyanate, and the like.

### <Dicarboxylic Acids>

oxalic acid, malonic acid, succinic acid, glutaric acid, adipic acid, suberic acid, azelaic acid, sebacic acid, undecanedioic acid, dodecanedioic acid, terephthalic acid, isophthalic acid, 5-hydroxyisophthalic acid, 2-chloroterephthalic acid, 2-methylterephthalic acid, 5-methylisophthalic acid, 5-sodium sulfoisophthalic acid, hexahydroterephthalic acid, hexahydroisophthalic acid, cyclohexanedicarboxylic acid, biphenyldicarboxylic acid, naphthalenedicarboxylic acid, benzophenonedicarboxylic acid, furandicarboxylic acid, 4,4′-dicarboxydiphenyl ether, 4,4′-dicarboxydiphenyl sulfide, and the like.

### <Acid Chlorides>

acetyl chloride, acrylic acid chloride, methacrylic acid chloride, malonyl chloride, succinic acid dichloride, diglycolyl chloride, glutaric acid dichloride, suberic acid dichloride, sebacic acid dichloride, adipic acid dichloride, dodecandioyl dichloride, azelayl chloride, 2,5-furandicarbonyl dichloride, phthaloyl chloride, isophthaloyl chloride, terephthaloyl chloride, trimesic acid chloride, bis(4-chlorocarbonylphenyl) ether, 4,4′-diphenyldicarbonyl chloride, 4,4′-azodibenzoyl dichloride, etc.

### <Lactams>

ε-caprolactam, ω-undecanelactam, ω-laurolactam, etc.

### [Polyimide Resin]

Examples of polyimide resins include, but are not limited to, reaction products of the diamines described above with the following tetracarboxylic dianhydrides. These may be used alone or in combination.

### <Tetracarboxylic Dianhydrides>

4,4′-(hexafluoroisopropylidene)diphthalic anhydride, 5-(2,5-dioxotetrahydro-3-furanyl)-3-methyl-cyclohexene-1,2 dicarboxylic anhydride, pyromellitic dianhydride, 1,2,3,4-benzenetetracarboxylic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 3,3′,4,4′-diphenylsulfonate tetracarboxylic dianhydride, 2,2′,3,3′-biphenyltetracarboxylic dianhydride, methylene-4,4′-diphthalic dianhydride, 1,1-ethylidene-4,4′-diphthalic dianhydride, 2,2′-propylidene-4,4′-diphthalic dianhydride, 1,2-ethylene-4,4′-diphthalic dianhydride, 1,3-trimethylene-4,4′-diphthalic dianhydride, 1,4-tetramethylene-4,4′-diphthalic dianhydride, 1,5-pentamethylene-4,4′-diphthalic dianhydride, 4,4′-oxydiphthalic dianhydride anhydride, thio-4,4′-diphthalic dianhydride, sulfonyl-4,4′-diphthalic dianhydride, 1,3-bis(3,4-dicarboxyphenyl)benzene dianhydride, 1,3-bis(3,4-dicarboxyphenoxy)benzene dianhydride, 1,4-bis(3,4-dicarboxyphenoxy)benzene dianhydride, 1,3-bis[2-(3,4-dicarboxyphenyl)-2-propyl]benzene dianhydride, 1,4-bis[2-(3,4-dicarboxyphenyl)-2-propyl]benzene dianhydride, bis[3-(3,4-dicarboxyphenoxy)phenyl]methane dianhydride, bis[4-(3,4-dicarboxyphenoxy)phenyl]methane dianhydride, 2,2-bis[3-(3,4-dicarboxyphenoxy)phenyl]propane dianhydride, 2,2-bis[4-(3,4-dicarboxyphenoxy)phenyl]propane dianhydride, bis(3,4-dicarboxyphenoxy)dimethylsilane dianhydride, 1,3-bis(3,4-dicarboxyphenyl)-1,1,3,3-tetramethyldisiloxane dianhydride, 2,3,6,7-naphthalene tetracarboxylic dianhydride, 1,4,5,8-naphthalene tetracarboxylic dianhydride, 1,2,5,6-naphthalene tetracarboxylic dianhydride, 3,4,9,10-perylene tetracarboxylic dianhydride, 2,3,6,7-anthracene tetracarboxylic dianhydride, 1,2,7,8-phenanthrene tetracarboxylic dianhydride, ethylene tetracarboxylic dianhydride, 1,2,3,4-butane tetracarboxylic dianhydride, 1,2,3,4-cyclobutane tetracarboxylic dianhydride, cyclopentane tetracarboxylic dianhydride, cyclohexane-1,2,3,4-tetracarboxylic acid dianhydride, cyclohexane-1,2,4,5-tetracarboxylic acid dianhydride, 3,3′,4,4′-bicyclohexyltetracarboxylic acid dianhydride, carbonyl-4,4′-bis(cyclohexane-1,2-dicarboxylic acid)dianhydride, methylene-4,4′-bis(cyclohexane-1,2-dicarboxylic acid)dianhydride, 1,2-ethylene-4,4′-bis(cyclohexane-1,2-dicarboxylic acid)dianhydride, 1,1-ethylidene-4,4′-bis(cyclohexane-1,2-dicarboxylic acid)dianhydride, 2,2-propylidene-4,4′-bis(cyclohexane-1,2-dicarboxylic acid)dianhydride, oxy-4,4′-bis(cyclohexane-1,2-dicarboxylic acid)dianhydride, thio-4,4′-bis(cyclohexane-1,2-dicarboxylic acid)dianhydride, sulfonyl-4,4′-bis(cyclohexane-1,2-dicarboxylic acid)dianhydride, bicyclo[2,2,2]oct-7-ene-2,3,5,6-tetracarboxylic acid dianhydride, rel-[1S,5R,6R]-3-oxabicyclo[3,2,1]octane-2,4-dione-6-spiro-3′-(tetrahydrofuran-2′,5′-dione), 4-(2,5-dioxotetrahydrofuran-3-yl)-1,2,3,4-tetrahydronaphthalene-1,2-dicarboxylic anhydride, ethylene glycol-bis-(3,4-dicarboxylic anhydride phenyl) ether, 4,4′-biphenyl bis(trimellitic acid monoester acid anhydride), 9,9′-bis(3,4-dicarboxyphenyl) fluorene dianhydride, and the like.

[Maleimide Compound Other than Maleimide Compound Having Maleimide Equivalent of 450 g/Eq. Or More and 2000 g/Eq. Or Less]

The curable resin composition of the present embodiment may contain a maleimide compound other than the maleimide compound having a maleimide equivalent of 450 g/eq. or more and 2000 g/eq. or less, and may contain a maleimide compound having a maleimide equivalent of less than 450 g/eq., or a maleimide compound having a maleimide equivalent of more than 2000 g/eq. Examples include, but are not limited to: 4,4′-diphenylmethane bismaleimide, polyphenylmethane maleimide, m-phenylene bismaleimide, 2,2′-bis[4-(4-maleimidophenoxy)phenyl]propane, 3,3′-dimethyl-5,5′-diethyl-4,4′-diphenylmethane bismaleimide, 4-methyl-1,3-phenylene bismaleimide, 4,4′-diphenylether bismaleimide, 4,4′-diphenylsulfone bismaleimide, 1,3-bis(3-maleimidophenoxy)benzene, 1,3-bis(4-maleimidophenoxy)benzene; Xylox type maleimide compounds (anilix maleimide, manufactured by Mitsui Chemicals Fine Co., Ltd.), biphenylaralkyl-type maleimide compound (solidified by distilling off the solvent under reduced pressure from a resin solution containing the maleimide compound (M2) described in Example 4 of JP 2009-001783A), bisaminocumylbenzene-type maleimide (maleimide compound described in WO 2020/054601A), maleimide compounds having an indane structure described in JP 6629692B or WO 2020/217679A, maleimide compounds described in MATERIAL STAGE Vol. 18, No. 12, 2019 “Sequel Epoxy Resin CAS Number Story-Hardener CAS Number Memorandum No. 31 Bismaleimide (1)” and MATERIAL STAGE Vol. 19, No. 2, 2019 “Sequel Epoxy Resin CAS Number Story-Hardener CAS Number Memorandum, No. 32 Bismaleimide (2)”. These compounds may be used alone or in combination.

### [Cyanate Ester Resin]

Cyanate ester resin is a cyanate ester compound obtained by reacting a phenolic resin with a cyanogen halide. Specific examples include dicyanatobenzene, tricyanatobenzene, dicyanatonaphthalene, dicyanatobiphenyl, 2,2′-bis(4-cyanatophenyl)propane, bis(4-cyanatophenyl)methane, bis(3,5-dimethyl-4-cyanatophenyl)methane, 2,2′-bis(3,5-dimethyl-4-cyanatophenyl)propane, 2,2′-bis(4-cyanatophenyl)ethane, 2,2′-bis(4-cyanatophenyl)hexafluoropropane, bis(4-cyanatophenyl)sulfone, bis(4-cyanatophenyl)thioether, phenol novolac cyanate, and phenol-dicyclopentadiene co-condensates in which the hydroxy groups have been converted to cyanate groups, but are not limited thereto. These may be used alone or in combination.

The cyanate ester compound, the synthesis method of which is described in JP-A-2005-264154, is particularly preferred as the cyanate ester compound, since it has low moisture absorption, flame retardancy, and excellent dielectric properties.

The cyanate ester resin may contain a catalyst such as zinc naphthenate, cobalt naphthenate, copper naphthenate, lead naphthenate, zinc octylate, tin octylate, lead acetylacetonate, or dibutyltin maleate, in order to trimerize the cyanate group to form a sym-triazine ring, as necessary.

The catalyst is preferably used in an amount of 0.0001 to 0.10 parts by weight, and more preferably 0.00015 to 0.0015 parts by weight, based on 100 parts by weight of the cyanate ester resin and the curable resin composition.

### [Polybutadiene and its Modified Products]

Polybutadiene and its modified products are compounds having polybutadiene or a structure derived from polybutadiene in the molecule. The structure derived from polybutadiene may have some or all of the unsaturated bonds converted to single bonds by hydrogenation.

Examples of polybutadiene and its modified products include, but are not limited to, polybutadiene, hydroxy-terminated polybutadiene, (meth)acrylate-terminated polybutadiene, carboxylic acid-terminated polybutadiene, amine-terminated polybutadiene, styrene butadiene rubber, etc. Also, these may be used alone or in combination. Of these, polybutadiene or styrene butadiene rubber is preferred from the viewpoint of dielectric properties. Examples of styrene butadiene rubber (SBR) include RICON-100, RICON-181, and RICON-184 (all manufactured by Cray Valley Corporation), and 1,2-SBS (manufactured by Nippon Soda Co., Ltd.). Examples of polybutadiene include B-1000, B-2000, and B-3000 (all manufactured by Nippon Soda Co., Ltd.). The molecular weight of polybutadiene and styrene butadiene rubber is preferably a weight average molecular weight of 500 to 10,000, more preferably 750 to 7,500, and even more preferably 1,000 to 5,000. Below the lower limit of the above range, the amount of volatilization is large, making it difficult to adjust the solid content when preparing the prepreg, and above the upper limit of the above range, the compatibility with other curable resins is deteriorated. In general, in the case of compounds containing heteroatoms such as oxygen and nitrogen, such as bismaleimide and polymaleimide, it is difficult to ensure compatibility with low-polarity compounds such as compounds mainly composed of hydrocarbons or compounds composed only of hydrocarbons due to their polarity. On the other hand, the compound of the present embodiment does not have a skeleton design in which heteroatoms such as oxygen and nitrogen are actively introduced, and therefore has excellent compatibility with materials exhibiting low polarity and low dielectric tangent, and with compounds composed only of hydrocarbons.

### [Polystyrene and Modified Products Thereof]

Polystyrene and modified products thereof are polystyrene or compounds having a structure derived from polystyrene in the molecule.

Examples of polystyrene and modified products thereof include, but are not limited: polystyrene, styrene-2-isopropenyl-2-oxazoline copolymers (Epocross RPS-1005, RP-61, both manufactured by Nippon Shokubai Co., Ltd.), SEP (styrene-ethylene-propylene copolymer: Septon (registered trademark) 1020, manufactured by Kuraray Co., Ltd.), SEPS (styrene-ethylene-propylene-styrene copolymer: Septon 2002, Septon 2004F, Septon 2005, Septon 2006, Septon 2063, Septon 2104, all manufactured by Kuraray Co., Ltd.), SEEPS (styrene-ethylene/ethylene-propylene-styrene block copolymer: Septon 4003, Septon 4044, Septon 4055, Septon 4077, Septon 4099, all manufactured by Kuraray Co., Ltd.), and SEBS (styrene-ethylene-butylene-styrene block copolymer: Septon 8004, Septon 8006, Septon 8007L, all manufactured by Kuraray Co., Ltd.), SEEPS-OH (a styrene-ethylene/ethylene propylene-styrene block copolymer having a hydroxy group at the end: SEPTON HG252, manufactured by Kuraray Co., Ltd.), SIS (styrene-isoprene-styrene block copolymer: SEPTON 5125, SEPTON 5127, manufactured by Kuraray Co., Ltd.), hydrogenated SIS (hydrogenated styrene-isoprene-styrene block copolymer: HYBLER (registered trademark) 7125F, HYBLER 7311F, manufactured by Kuraray Co., Ltd.), SIBS (styrene-isobutylene-styrene block copolymer: SIBSTAR (registered trademark) 073T, SIBSTAR 102T, SIBSTAR 103T, manufactured by Kaneka Corporation), and SEPTON V9827 (manufactured by Kuraray Co., Ltd.). These may be used alone or in combination. Polystyrene and modified products thereof have higher heat resistance and are less susceptible to oxidative deterioration, so it is preferable that they do not have unsaturated bonds. The weight-average molecular weight of polystyrene and modified products thereof is not particularly limited as long as it is 10,000 or more, but if it is too large, the compatibility with not only polyphenylene ether compounds but also low molecular weight components with a weight-average molecular weight of about 50 to 1,000 and oligomer components with a weight-average molecular weight of about 1,000 to 5,000 deteriorates, making it difficult to ensure mixing and solvent stability, so it is preferably about 10,000 to 300,000.

### [Polyethylene and Modified Products Thereof]

Polyethylene and modified products thereof are compounds having polyethylene or a structure derived from polyethylene in the molecule. Examples of polyethylene and modified products thereof include ethylene-propylene copolymers, ethylene-styrene copolymers, ethylene-propylene-ethylidene norbornene copolymers (EBT: K-8370EM, K-9330M, etc., manufactured by Mitsui Chemicals, Inc.), ethylene-propylene-vinyl norbornene copolymers (VNB-EPT: PX-006M, PX-008M, PX-009M, etc., manufactured by Mitsui Chemicals, Inc.), ethylene-vinyl alcohol copolymers, ethylene-vinyl acetate copolymers, etc., but are not limited thereto. From the viewpoint of improving heat resistance, it is preferable to use ethylene-propylene-ethylidene norbornene copolymers and ethylene-propylene-vinyl norbornene copolymers containing a crosslinkable structure. In addition, these may be used alone or in combination. The weight average molecular weight of the polyethylene and modified products thereof is not particularly limited as long as it is 10,000 or more. However, if it is too large, compatibility with not only the polyphenylene ether compound but also low molecular weight components having a weight average molecular weight of about 50 to 1,000 and oligomer components having a weight average molecular weight of about 1,000 to 5,000 deteriorates, making it difficult to ensure mixing and solvent stability. Therefore, it is preferably about 10,000 to 300,000.

The curable resin composition of the present embodiment can be obtained by preparing the above-mentioned components in a predetermined ratio, pre-curing at 130° C. to 180° C. for 30 to 500 seconds, and then post-curing at 150° C. to 200° C. for 2 to 15 hours, whereby a sufficient curing reaction proceeds to obtain a cured product of the present embodiment. Alternatively, the components of the curable resin composition can be uniformly dispersed or dissolved in a solvent or the like, and cured after removing the solvent.

The method for preparing the curable resin composition of the present embodiment is not particularly limited, but each component may be mixed uniformly or may be prepolymerized. For example, a mixture containing the compound of the present embodiment is heated in the presence or absence of a curing accelerator or a polymerization initiator, and in the presence or absence of a solvent to form a prepolymer. Similarly, an amine compound, a compound having an ethylenically unsaturated bond, a maleimide compound, a cyanate ester compound, polybutadiene and its modified products, polystyrene and its modified products, inorganic fillers, and other additives may be added to form a prepolymer. The mixing or prepolymerization of each component is carried out using, for example, an extruder, a kneader, a roll, or the like in the absence of a solvent, and a reaction kettle with a stirrer in the presence of a solvent.

As a method of uniform mixing, the materials are mixed at a temperature in the range of 50° C. to 100° C. by kneading with a device such as a kneader, roll, or planetary mixer to obtain a uniform resin composition. The obtained resin composition is crushed and then molded into a cylindrical tablet shape using a molding machine such as a tablet machine, or into a granular powder or powder molded body, or these compositions can be melted on a surface support and molded into a sheet shape with a thickness of 0.05 mm to 10 mm to obtain a molded curable resin composition. The obtained molded body is a non-sticky molded body at 0° C. to 20° C., and even if stored at −25° C. to 0° C. for one week or more, the flowability and curability are hardly reduced.

The obtained molded body can be molded into a cured product using a transfer molding machine or a compression molding machine.

The curable resin composition of the present embodiment can be made into a varnish-like composition (hereinafter, simply referred to as varnish) by adding an organic solvent. The curable resin composition of the present embodiment can be dissolved in a solvent such as toluene, xylene, acetone, methyl ethyl ketone, methyl isobutyl ketone, dimethylformamide, dimethylacetamide, or N-methylpyrrolidone as necessary to form a varnish, which is then impregnated into a substrate such as glass fiber, carbon fiber, polyester fiber, polyamide fiber, alumina fiber, or paper, and dried by heating to obtain a prepreg, which is then hot-press molded to obtain a cured product of the curable resin composition of the present embodiment. The solvent used in this case is in an amount that occupies 10 to 70% by weight, preferably 15 to 70% by weight, in the mixture of the curable resin composition of the present embodiment and the solvent. In addition, if the composition is in a liquid state, a cured product of the curable resin containing carbon fiber can be obtained as it is, for example, by the RTM method.

The curable resin composition of the present embodiment can also be used as a modifier for a film-type composition. Specifically, it can be used to improve flexibility and the like in the B-stage. Such a film-type resin composition can be obtained as a sheet-like adhesive by applying the curable resin composition of the present embodiment as a varnish onto a release film, removing the solvent under heating, and then performing B-stage formation. This sheet-like adhesive can be used as an interlayer insulating layer in a multilayer substrate or the like.

The curable resin composition of the present embodiment can be heated and melted to reduce the viscosity, and impregnated into reinforced fibers such as glass fibers, carbon fibers, polyester fibers, polyamide fibers, and alumina fibers to obtain a prepreg. Specific examples thereof include glass fibers such as E glass cloth, D glass cloth, S glass cloth, Q glass cloth, spherical glass cloth, NE glass cloth, and T glass cloth, inorganic fibers other than glass, and organic fibers such as polyparaphenylene terephthalamide (Kevlar (registered trademark), manufactured by DuPont), wholly aromatic polyamide, polyester, polyparaphenylene benzoxazole, polyimide, and carbon fibers, but are not particularly limited thereto. The shape of the substrate is not particularly limited, but examples thereof include woven fabric, nonwoven fabric, roving, chopped strand mat, and the like. In addition, as the weaving method of the woven fabric, plain weave, saddle weave, twill weave, and the like are known, and these known weaves can be appropriately selected and used depending on the intended use and performance. In addition, woven fabrics that have been subjected to fiber opening treatment and glass woven fabrics that have been surface-treated with a silane coupling agent or the like are preferably used. The thickness of the substrate is not particularly limited, but is preferably about 0.01 to 0.4 mm. A prepreg can also be obtained by impregnating reinforcing fibers with the varnish and drying the fibers by heating.

Moreover, a laminate can be manufactured using the prepreg. The laminate is not particularly limited as long as it has one or more prepregs, and may have any other layer. The manufacturing method of the laminate can be appropriately applied by a generally known method, and is not particularly limited. For example, when molding a metal foil-clad laminate, a multi-stage press machine, a multi-stage vacuum press machine, a continuous molding machine, an autoclave molding machine, etc. can be used, and the prepregs are laminated together and heated and pressurized to obtain a laminate. At this time, the heating temperature is not particularly limited, but is preferably 65 to 300° C., and more preferably 120° C. to 270° C. In addition, the pressure to be applied is not particularly limited, but if the pressure is too high, it is difficult to adjust the solid content of the resin of the laminate, and the quality is not stable, and if the pressure is too low, air bubbles and adhesion between the laminates are deteriorated, so that 2.0 to 5.0 MPa is preferable, and 2.5 to 4.0 MPa is more preferable. The laminate of this embodiment can be suitably used as a metal foil-clad laminate described later by providing a layer made of metal foil.

The prepreg is cut into a desired shape and laminated with copper foil or the like as necessary. The laminate is then heated and cured while applying pressure thereto by press molding, autoclave molding, sheet winding molding or the like, to obtain an electrical and electronic laminate (printed wiring board) or a carbon fiber reinforced material.

The curable resin composition of this embodiment can also be made into a resin sheet. As a method for obtaining a resin sheet from the curable resin composition of this embodiment, for example, a method of applying the curable resin composition onto a support film (support), drying it, and forming a resin composition layer on the support film can be mentioned. When the curable resin composition of this embodiment is used for a resin sheet, it is essential that the film softens under the temperature conditions (70° C. to 140° C.) of lamination in the vacuum lamination method, and simultaneously with lamination of the circuit board, exhibits a fluidity (resin flow) that allows resin filling in via holes or through holes present in the circuit board, and it is preferable to blend each of the components so as to express such characteristics. In addition, in the obtained resin sheet or circuit board (copper-clad laminate, etc.), a phenomenon that locally different characteristic values are exhibited due to phase separation or the like is not caused, and a certain performance is expressed at any part, so that a uniform appearance is required.

Here, the diameter of the through-holes in the circuit board is 0.1 to 0.5 mm, and the depth is 0.1 to 1.2 mm, and it is preferable to make it possible to fill the resin within this range. When laminating both sides of the circuit board, it is preferable to fill about ½ of the through-holes.

A specific method for producing the resin sheet includes preparing a resin composition varnished by blending an organic solvent, applying the varnished resin composition to the surface of a support film (Y), and then drying the organic solvent by heating or blowing hot air or the like to form a resin composition layer (X).

The organic solvent used here is preferably, for example, ketones such as acetone, methyl ethyl ketone, cyclohexanone, etc., acetates such as ethyl acetate, butyl acetate, cellosolve acetate, propylene glycol monomethyl ether acetate, carbitol acetate, etc., carbitols such as cellosolve, butyl carbitol, etc., aromatic hydrocarbons such as toluene, xylene, etc., dimethylformamide, dimethylacetamide, N-methylpyrrolidone, etc. It is also preferable to use the organic solvent in such a proportion that the nonvolatile content is 30 to 60% by weight of the total.

The thickness of the resin composition layer (X) to be formed must be equal to or greater than the thickness of the conductor layer of the circuit board to which the resin composition layer (X) is laminated. Since the thickness of the conductor layer of the circuit board is in the range of 5 to 70 μm, the thickness of the resin composition layer (X) is preferably 10 to 100 μm. The resin composition layer (X) in this embodiment may be protected with a protective film to be described later. By protecting the resin composition layer (X) with a protective film, it is possible to prevent the adhesion of dirt and the like to the surface of the resin composition layer (X) and scratches.

The support film and the protective film may be made of a polyolefin such as polyethylene, polypropylene, or polyvinyl chloride, a polyester such as polyethylene terephthalate (PET) or polyethylene naphthalate, a polycarbonate, or a polyimide, or may be a release paper or a metal foil such as a copper foil or an aluminum foil. The support film and the protective film may be subjected to a release treatment in addition to a matte treatment or a corona treatment. The thickness of the support film is not particularly limited, but is in the range of 10 to 150 μm, and preferably 25 to 50 μm. The thickness of the protective film is preferably 1 to 40 μm.

The support film (Y) is peeled off after laminating the resin composition layer (X) on a circuit board, or after forming an insulating layer by heat-curing the resin composition layer (X). If the support film (Y) is peeled off after the resin composition layer (X) constituting the resin sheet is heat-cured, adhesion of dust and the like during the curing process can be prevented. When the support film (Y) is peeled off after the resin composition layer (X) is cured, the support film (Y) is previously subjected to a release treatment.

A multilayer printed circuit board can be manufactured from the resin sheet obtained as described above. For example, when the resin composition layer (X) is protected by a protective film, the protective film is peeled off from the resin composition layer (X), and then the resin composition layer (X) is laminated on one or both sides of the circuit board so as to be in direct contact with the circuit board, for example, by a vacuum lamination method. The lamination method may be a batch type or a continuous type using a roll. If necessary, the resin sheet and the circuit board may be heated (preheated) before lamination. The lamination conditions are preferably a pressure bonding temperature (lamination temperature) of 70 to 140° C., a pressure bonding pressure of 1 to 11 kgf/cm² (9.8×10⁴ to 107.9×10⁴ N/m²), and lamination is preferably performed under reduced pressure of 20 mmHg (26.7 hPa) or less. In addition, the curable resin composition of the present embodiment can be used to manufacture a semiconductor device, such as a dual in-line package (DIP), a quad flat package (QFP), a ball grid array (BGA), a chip size package (CSP), a small outline package (SOP), a thin small outline package (TSOP), a thin quad flat package (TQFP), etc.

The curable resin composition of the present embodiment and its cured product can be used in a wide range of fields. Specifically, it can be used in various applications such as molding materials, adhesives, composite materials, and paints. The cured product of the curable resin composition described in this embodiment exhibits excellent heat resistance and dielectric properties, and is therefore suitable for use in electrical and electronic components such as semiconductor element encapsulants, liquid crystal display element encapsulants, organic EL element encapsulants, laminates (printed wiring boards, BGA substrates, build-up substrates, etc.), carbon fiber reinforced plastics, glass fiber reinforced plastics, and other lightweight and high-strength structural composite materials, 3D printing, and the like.

### EXAMPLES

The present invention will now be described in more detail with reference to examples. Unless otherwise specified, all parts are by weight. However, the present invention is not limited to these examples.

The various analytical methods used in the examples are described below.
GPC (gel permeation chromatography) analysis
equipment: online degassing unit (DGU-20A), liquid delivery unit (LC-20AD), autosampler (SIL-20A), photodiode array detector (SPD-M40), column oven (CTO-20A), system controller (CBM-20A), all manufactured by Shimadzu Corporation
Columns: SHODEX GPC KF-601 (2 columns), KF-602, KF-602.5, KF-603 Flow rate: 1.5 ml/min.
Column temperature: 40° C.
Solvent used: THF (tetrahydrofuran)
Detector: differential refractive index detector (RID-20A), manufactured by Shimadzu Corporation

### Synthesis Example 1

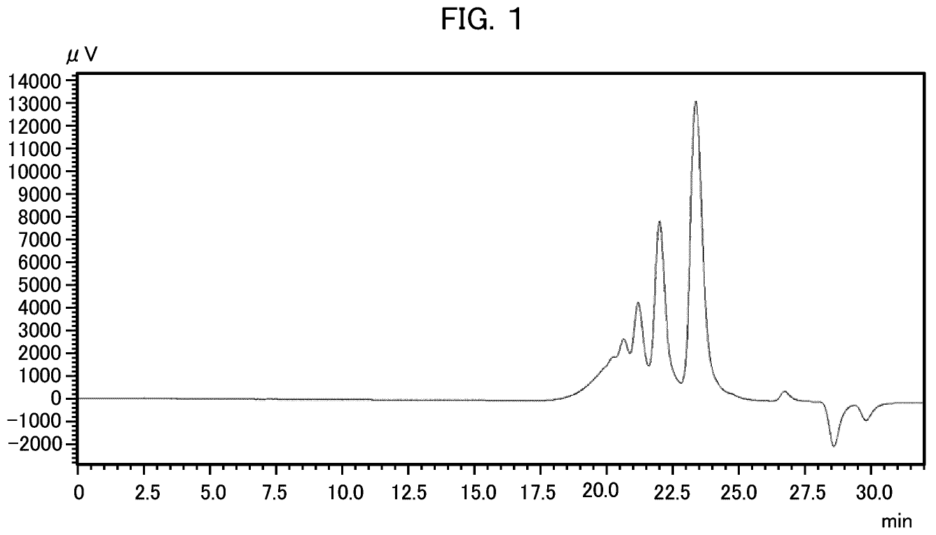

A thermometer, a cooling tube, and a stirrer were attached to the flask, and a base trap and an aspirator were connected to the cooling tube. 370.1 parts of 2-bromoethylbenzene (manufactured by Tokyo Chemical Industry Co., Ltd.), 175.1 parts of α,α′-dichloro-p-xylene (manufactured by Tokyo Chemical Industry Co., Ltd.), and 27.3 parts of methanesulfonic acid (manufactured by Tokyo Chemical Industry Co., Ltd.) were charged into this flask, and the reaction was carried out at 130° C. for 6 hours while collecting the generated hydrogen chloride with a base trap. Then, 100 parts of toluene and 600 parts of cyclohexane were added to the flask to extract the product, and the organic layer was washed five times with 100 parts of water. By distilling off the solvent and excess 2-bromoethylbenzene under heating and reduced pressure, 380 parts of a compound (BEB-1) having a 2-bromoethylbenzene structure represented by the following formula (3) was obtained as a liquid resin (Mn: 938, Mw: 1290). The GPC chart of the obtained compound is shown in FIG. 1. The average number of repetitions, n, calculated from the area % of the GPC chart was 2.2.

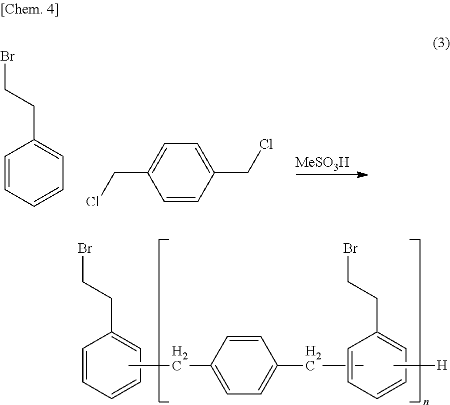

### Synthesis Example 2

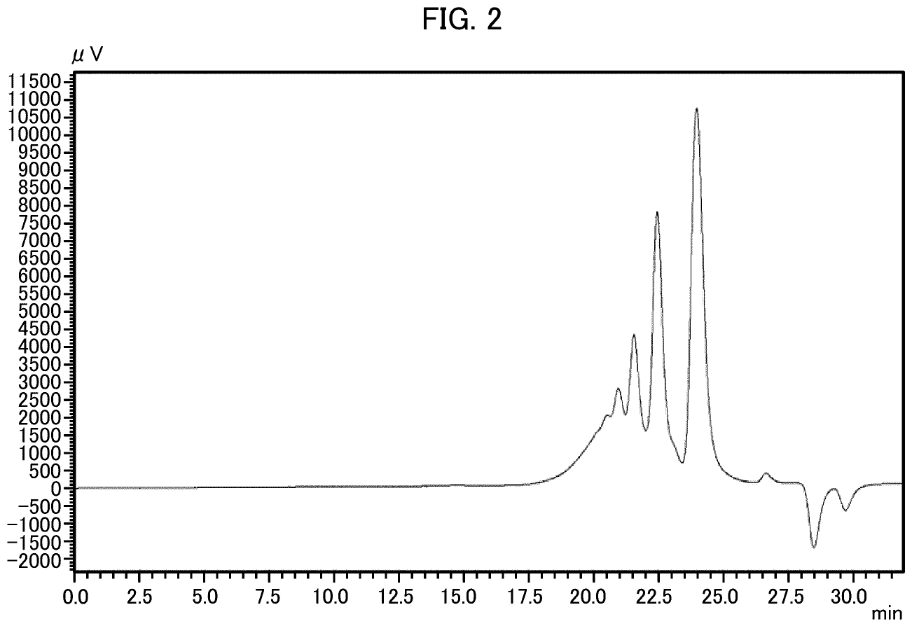

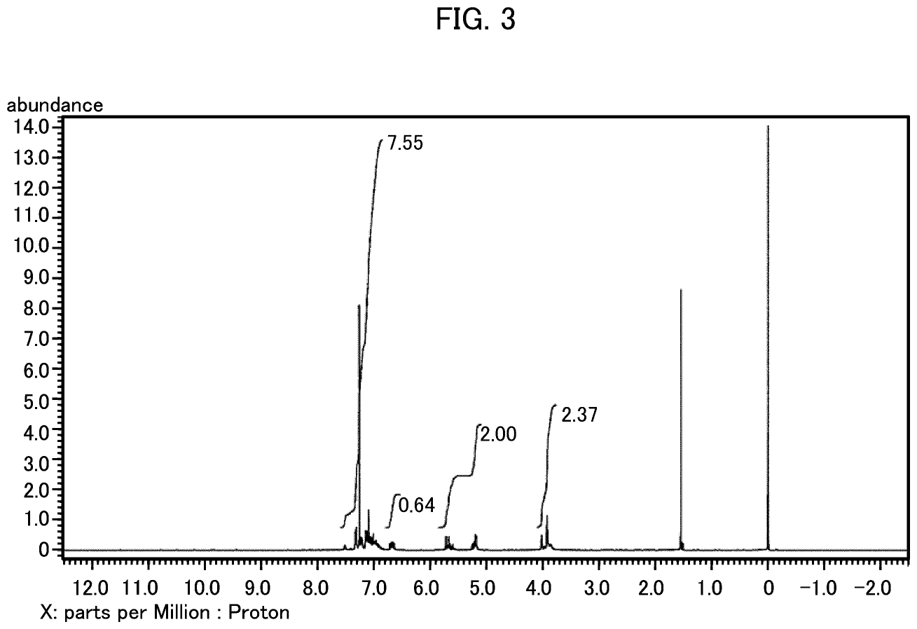

300 parts of BEB-1 obtained in Synthesis Example 1, 245 parts of toluene, 735 parts of dimethyl sulfoxide, 0.15 parts of 4-hydroxy-2,2,6,6-tetramethylpiperidine-1-oxyl free radical, and 146.4 parts of 50 wt % aqueous sodium hydroxide solution were added to a flask equipped with a thermometer, a cooling tube, and a stirrer, and the reaction was continued for 6 hours at 40° C. 100 parts of water were added to the flask, the organic layer was washed, and the organic layer was returned to the flask. 735 parts of dimethyl sulfoxide and 9.8 parts of 50 wt % aqueous sodium hydroxide solution were added to the organic layer, and the reaction was continued for 1 hour at 40° C., 300 parts of toluene were added, and the organic layer was repeatedly washed with 100 parts of water until the wastewater became neutral. The mixture was concentrated under reduced pressure using an evaporator, and 180 parts of a compound (O-1) having two or more styrene structures in the molecule represented by the following formula (4) was obtained. The GPC chart of the obtained compound is shown in FIG. 2. The ¹H-NMR data (deuterated chloroform) of the obtained compound is shown in FIG. 3. Signals derived from vinyl groups were observed at 5.10-5.30 ppm, 5.50-5.85 ppm, and 6.60-6.80 ppm in the ¹H-NMR chart. The average repeat number n calculated from the area % of the GPC chart was 2.2 (the molecular weight of the resin component was Mn: 797, Mw: 1187).

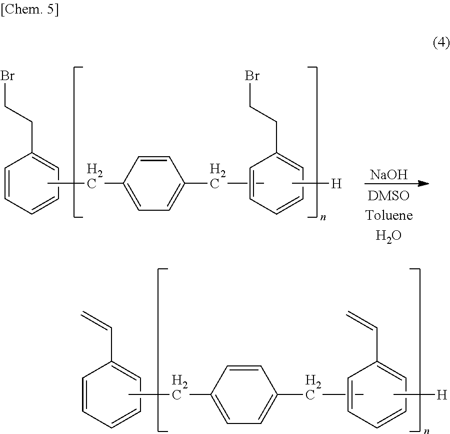

MI-1: According to Example 7 of Japanese Patent Publication No. 7208705, a maleimide compound having the following formula (5) as a representative structure was synthesized (the structural units in the brackets enclosed by 1 and m are each bonded randomly). The maleimide equivalent measured by the method described in Japanese Patent Publication No. 2020-187012 was 530 g/eq.

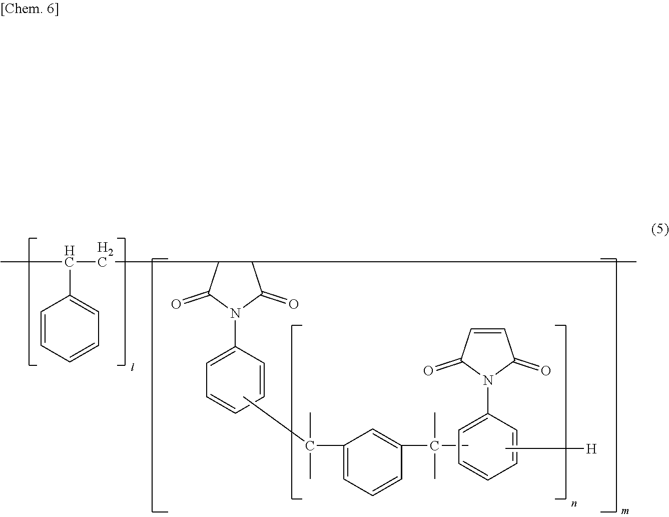

MI-2: According to Example 4 of Japanese Patent Publication No. 7182343, a maleimide compound having the following formula (6) as a representative structure was synthesized (the structural units in parentheses enclosed by p and q are each bonded randomly). The maleimide equivalent measured by the method described in Japanese Patent Publication No. 2020-187012 was 710 g/eq.

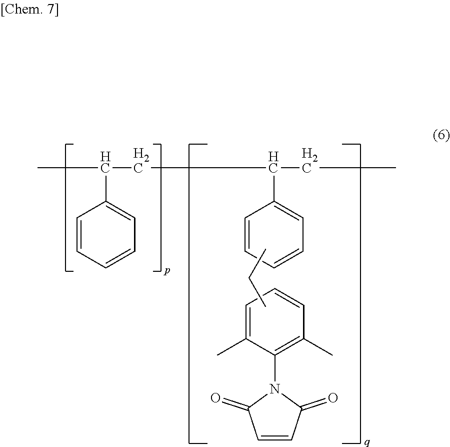

MI-3: A maleimide compound having the following formula (7) as a representative structure was synthesized according to Example 1 of JP 2022-176111 A (the structural units in the brackets enclosed by s, t, and u are each randomly bonded.) The maleimide equivalent measured by the method described in JP 2020-187012 A was 520 g/eq.

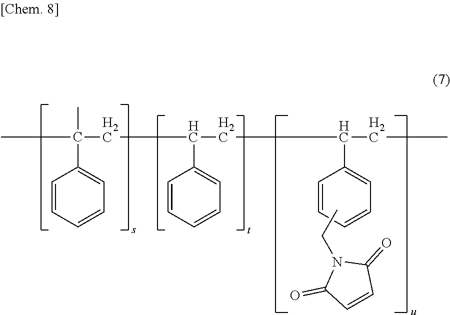

MI-4: A maleimide compound represented by the following formula (8) (manufactured by Tokyo Chemical Industry Co., Ltd.) The maleimide equivalent calculated from the molecular weight and the number of functional groups was 221 g/eq.

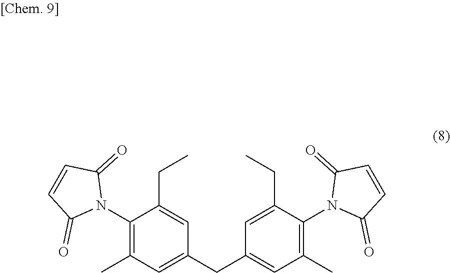 [SMILES: CCc1cc(Cc2cc(C)c(N3C(=O)C=CC3=O)c(CC)c2)cc(C)c1N1C(=O)C=CC1=O]

### Examples 1-3, Comparative Example 1

A toluene solution (OS-1) containing 60% by weight of the compound (0-1) obtained in Synthesis Example 2, maleimide compounds (MI-1) to (MI-4), polyphenylene ether compound (OPE-2St: manufactured by Mitsubishi Gas Chemical Co., Ltd.), and toluene were dissolved and mixed in the amounts shown in Table 1, and the mixture was applied to a mirror-finished copper foil and pre-dried at 60° C. for 30 minutes in a vacuum oven.

After pre-drying, the mixture was cured at 220° C. for 1 hour in Examples 1-3. The mixture of Comparative Example 1 was cured at 175° C. for 2 hours.

After curing, the copper foil was etched using ferric chloride to obtain a cured film. If necessary, a test piece of the desired size was cut using a laser cutter and evaluated.

### <Dielectric Loss Tangent Test>

A 10 GHz cavity resonator manufactured by AET Co., Ltd. was used to perform a test at 25° C. using a cavity resonator perturbation method. The size of the test piece was 1.7 mm wide×100 mm long×0.1 mm thick, and the test was performed. The dielectric loss tangent at this time was evaluated as the initial value. The test piece after the initial value measurement was immersed in water at 25° C. for 24 hours and the measured value was taken as the dielectric loss tangent after water absorption. In addition, the test piece after the initial value measurement was left at 150° C. for 24 hours and the measured value was taken as the dielectric loss tangent after high temperature storage. The evaluation results are shown in Table 1.

TABLE 1

| | | Maleimide | | | | |
|---|---|---|---|---|---|---|
| | | equivalent | | | | Comparative |
| | | (g/eq.) | Example 1 | Example 2 | Example 3 | Example 1 |
| Olefin | OS-1 | — | 117 | 117 | 117 | 117 |
| compound | | | | | | |
| Maleimide | MI-1 | 530 | 70 | | | |
| compound | MI-2 | 710 | | 70 | | |
| | MI-3 | 52 | | | 70 | |
| | MI-4 | 221 | | | | 70 |
| Polyphenylene | PPE | — | 60 | 60 | 60 | 60 |
| Ether | | | | | | |
| Compound | | | | | | |
| Solvent | Toluene | — | 86 | 86 | 86 | 86 |

Evaluation Results

| | | | | |
|---|---|---|---|---|
| Dieletric Loss Tangent | 0.00173 | 0.00121 | 0.00136 | 0.00192 |
| (Intial value) | | | | |
| Dieletric Loss Tangent | 0.00214 | 0.00147 | 0.00145 | 0.00274 |
| (After water absorption) | | | | |
| Dieletric Loss Tangent | 0.00284 | 0.00266 | 0.00260 | 0.00476 |
| (After high temperature storage) | | | | |

From the results in Table 1, it was confirmed that the curable resin composition of the present invention has a low dielectric tangent and excellent dielectric properties not only at the initial stage but also after the water absorption test and the high temperature storage test.

This application claims priority based on Japanese Patent Application No. 2023-046175 filed on Mar. 23, 2023.

### INDUSTRIAL APPLICABILITY

The curable resin composition of the present invention is suitably used for electric and electronic parts such as semiconductor encapsulants, printed wiring boards, and build-up laminates.

1. A curable resin composition comprising:
a compound represented by the following formula (1); and
a maleimide compound having a maleimide equivalent of 450 g/eq. or more and 2000 g/eq. or less: 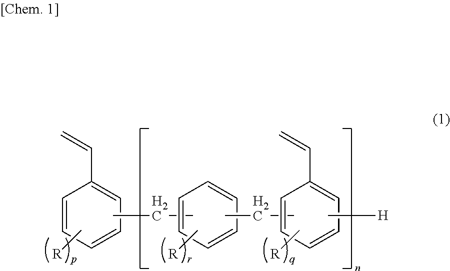
wherein, in formula (1),
each of the multiple R independently represents a hydrogen atom, a hydrocarbon group having 1 to 10 carbon atoms, or a halogenated alkyl group having 1 to 10 carbon atoms,
p represents an integer of 0 to 4,
r represents an integer of 0 to 4, and
q represents an integer of 0 to 3,
n represents the average number of repetitions, and is 1≤n≤20.

2. The curable resin composition according to claim 1,
wherein the maleimide compound has a polystyrene structure in the molecule.

3. The curable resin composition according to claim 1, further comprising a polymerization initiator.

4. The curable resin composition according to claim 1, further comprising at least one selected from the group consisting of: maleimide compounds other than the maleimide compound, polyphenylene ether compounds, compounds having an ethylenically unsaturated bond, cyanate ester resins, polybutadiene and modified products thereof, polystyrene and modified products thereof, and polyethylene and modified products thereof.

5. A cured product obtained by curing the curable resin composition according to claim 1.

6. A cured product obtained by curing the curable resin composition according to claim 2.

7. A cured product obtained by curing the curable resin composition according to claim 3.

8. A cured product obtained by curing the curable resin composition according to claim 4.
